(19) United States
(12) Patent Application Publication
(10) Pub. No.: US 2013/0157191 A1
(43) Pub. Date: Jun. 20, 2013

(54) TONER FOR ELECTROPHOTOGRAPHY AND IMAGE-FORMING METHOD

(71) Applicants: Kimihiko Ookubo, Hachioji-shi (JP); Ryohei Iwamoto, Hachioji-shi (JP); Keigo Tamaki, Machida-shi (JP); Yutaro Hakoi, Hachioji-shi (JP)

(72) Inventors: Kimihiko Ookubo, Hachioji-shi (JP); Ryohei Iwamoto, Hachioji-shi (JP); Keigo Tamaki, Machida-shi (JP); Yutaro Hakoi, Hachioji-shi (JP)

(73) Assignee: KONICA MINOLAT BUSINESS TECHNOLOGIES, INC., Tokyo (JP)

(21) Appl. No.: 13/819,854

(22) PCT Filed: Jul. 19, 2011
(86) PCT No.: PCT/JP2011/066314

§ 371 Date: Feb. 28, 2013

(30) Foreign Application Priority Data
Sep. 14, 2010 (JP) 2010-205371

(51) Int. Cl. G03G 9/09

(52) U.S. Cl. CPC G03G 9/0906
USPC 430/108.21; 548/262.4; 546/199; 544/140; 430/123.57

(57) ABSTRACT

The present invention provides a toner for electrophotography capable of achieving high color reproducibility in a wide brightness region ranging from high to low brightness. This toner for electrophotography containing a compound represented by general formula (X-1) is characterized in that when the toner image formed exclusively from the toner is at maximum saturation, the hue angle (H) of the toner in a CIE L*a*b* color space is within the range of 341°≦H≦351°. [Formula 1] (In the formula: one of Rx1 and Rx2 is a methyl group or an ethyl group, while the other represents an alkyl group with C12 or less optionally substituted by a group including an oxygen atom, or a 5- or 6-membered aliphatic ring optionally substituted by a group including an oxygen atom connecting a nitrogen atom and Rx1 and Rx2; and GX2 represents an alkyl group optionally substituted by a group including an oxygen atom.)

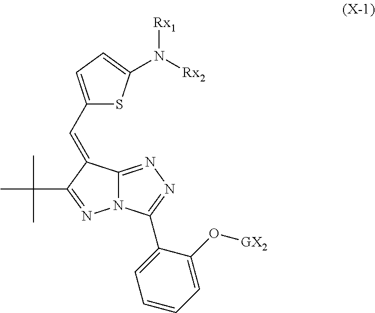

### TECHNICAL FIELD

The present invention relates to an electrophotographic toner containing a compound having a specific structure, and more specifically, the present invention relates to an electrophotographic toner additionally containing another specific compound in combination therewith.

### BACKGROUND

Among organic compounds, a material which gives color to an object by absorption of visible light is generally known as an organic colorant (hereafter, it is simply called as “colorant”). By making use of this function of giving color to an object, the colorant is widely used for various applications of dying agents for fibers; coloring materials for resin or coating; image forming materials in photography, printing, electrophotography, or printer; and light absorbing materials for color filter.

In recent years, it have been proposed various types of image forming colorants for color hard copies which use an ink-jet method, electrophotography, or a thermal transfer method. Moreover, with the development of electronic imaging, it has been increased a demand for: a filter dye used for a solid image pick-up tube or a liquid crystal color TV; and a colorant for an optical recording medium using a semiconductor laser. The application field of colorants has been expanding. The above-mentioned colorants are commonly expected to be provided with the following properties.

That is, the colorants are required: to have desirable hue with respect to color reproduction; to have outstanding spectral absorption characteristics; to show an excellent image fastness in light stability, heat stability, moisture resistance, and chemical resistance; and to have a large molar absorption coefficient.

In an image formation apparatus, such as a color copier or a color printer using an electrophotography method, a colorant is mixed and dispersed with a binder resin medium and used as an electrophotographic toner (hereafter, it is simply called as “a toner”). A colorant incorporated in the toner (in the electrophotographic filed, it is usually called as a coloring agent) is also required to be provided with the above-described properties. As properties required for an electrophotographic toner, there are cited: color reproductivity, transparency of an image and light stability, and further, prevention or decrease of contamination on a fixing roller surface or in an image foming apparatus such as a printer, or small degree ofblur of an image after fixing. It is disclosed a toner which improved these properties (for example, refer to Patent documents 1 and 2).

Especially, since a magenta toner has a color which exhibits high luminosity factor to human, it plays a very important role in color reproduction quality. In a common magenta toner, the actual situation is to suitably adjust the lightness, the chroma, and the hue angle of the monochrome image, and to take a balanced of color reproduction in a high lightness portion and a low lightness portion.

Recently, it was disclosed an electrophotographic toner which showed high color reproductivity, further suited to a toner manufacturing process, and exhibited high image storage stability (for example, refer to Patent documents 3 and 4). However, through the study based on the above-mentioned technologies by the present inventors, it was revealed that sufficient color reproductivity was not sufficiently achieved in the broad lightness portion from high to low lightness even with the electrophotographic toner according to the above-mentioned technological development. It is required to realize further high color reproductivity.

### PRIOR ART DOCUMENTS

### Patent Documents

Patent document 1: Japanese Patent Application Publication (hereafter it is called as JP-A) No. 2006-350300

Patent document 2: JP-A No. 2007-34264

Patent document 3: JP-A No. 2009-221280

Patent document 4: JP-A No. 2009-222847

### SUMMARY OF THE INVENTION

### Problems to be Solved by the Invention

The present invention was achieved to solve the above-mentioned problems. An object of the present invention is to provide an electrophotographic toner (hereafter, it is called a color toner or simply a toner) which enables to realize high color reproductivity in the wide lightness range from a high lightness portion to a low lightness portion.

### Means to Solve the Problems

As described above, it is a premise of an invention that the present invention uses a colorant excellent in the following properties which should usually be provided with as a commonly used toner: to have a preferable hue; to have outstanding spectral absorption characteristics; to be excellent in image stability of light stability, thermal stability, and moisture resistance; and to have a large molar absorption coefficient. Therefore, the structure of the colorant has a specific structure, as defined in each of the claims in Scope of claims.

Furthermore, an object of the present invention is to provide an electrophotographic toner which can realize a high color reproduction property in a wide lightness range from a high lightness portion to a low lightness portion. First, it was investigated a study from which an index for attaining the object. As a result, the present inventors found out that a hue angle (H) of a toner in CIF L*a*b* color space could serve as an index, and further defined a specific range of hue angle (H) which can achieve the object of the present invention.

That is, through the investigation by the present inventors, it was found that the object of the present invention can be achieved by taking the following compositions.
(1) An electrophotographic toner comprising a compound represented by Formula (X-1),
   wherein a hue angle (H) of the toner in CIE L*a*b* color space is in the range of:

341°≦H≦351°,
when a toner image formed only with the toner exhibits a maximum chroma.

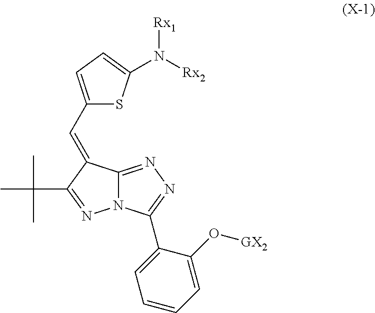

(In Formula, one of Rx₁ and Rx₂represents a methyl group or an ethyl group, and another one of Rx₁ and Rx₂ represents an alkyl group having 12 or less carbon atoms which may be substituted with an oxygen-containing group; or Rx₁ and Rx₂ represent a 5- or 6-membered aliphatic ring which may be substituted with an oxygen-containing group by combining Rx₁ and Rx₂ with a nitrogen atom; and GX₂ represents an alkyl group which may be substituted with an oxygen-containing group.)
(2) The electrophotographic toner described in the aforesaid item (1),
   wherein the toner further contains a pigment having a quinacridone structure in addition to the compound represented by Formula (X-1); and
   a hue angle (H) of the toner in CIE L*a*b* color space is in the range of:

341°≦H≦351°,
when a toner image formed only with the toner exhibits a maximum chroma.
(3) The electrophotographic toner described in the aforesaid item (1),
   wherein the toner further contains a compound represented by Formula (1) in addition to the compound represented by Formula (X-1); and
   a hue angle (H) of the toner in CIE L*a*b* color space is in the range of:

341°≦H≦351°,
when a toner image formed only with the toner exhibits a maximum chroma.

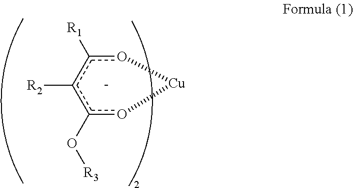

(In Formula, R₁ represents an alkyl group; R₂ represents a hydrogen atom, an alkoxycarbonyl group, an aryloxycarbonyl group, a sulfamoyl group, a sulfinyl group, an alkylsulfonyl group, an arylsulfonyl group, an acyl group, a halogen atom, or a cyano group; and R₃ represents a group containing an aromatic hydrocarbon structure having 9 or more carbon atoms.)
(4) An electrophotographic toner comprising a compound represented by Formula (X-1b).

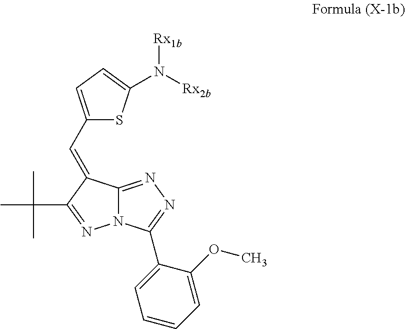

(In Formula, one of Rx_{1b} and Rx_{2b} represents a methyl group or an ethyl group, and another one of Rx_{1b} and Rx_{2b} represents an alkyl group having 4 or less carbon atoms which may be substituted with an oxygen-containing group, provided that a sum of carbon atoms of Rx_{1b} and Rx_{2b} is an integer of 3 to 5, or Rx_{1b} and Rx_{2b} represent a 5- or 6-membered aliphatic ring which may be substituted with an oxygen-containing group by combining Rx_{1b} and Rx_{2b} with a nitrogen atom.)
(5) The electrophotographic toner described in the aforesaid item (4),
   wherein a hue angle (H) of the toner in CIE L*a*b* color space is in the range of:

341°≦H≦351°,
when a toner image formed only with the toner exhibits a maximum chroma.
(6) The electrophotographic toner,
   wherein the toner image formed only with the toner described in any one of the aforesaid items (1) to (5) is formed by fixing using a heat roller fixing method composing a heat roller and a pressure roller.
(7) The electrophotographic toner,
   wherein the toner image formed only with the toner described in any one of the aforesaid items (1) to (6) is formed by being developed under the following conditions,
   surface electric potential of a photoreceptor: −700 V
   DC bias: −500 V
   distance between a photoreceptor and a developing sleeve: 600 μm
   regulation of a developer layer: magnetic H-Cut method
   developer layer thickness: 700 μm
   developing sleeve diameter: 40 mm.
(8) The electrophotographic toner,
   wherein the toner image formed only with the toner described in any one of the aforesaid items (1) to (7) is formed by being transferred on a transfer material having a glossiness of 5 to 80.
(9) A method for forming an image using the electrophotographic toner described in any one of the aforesaid items (1) to (8).

### Effects of the Invention

The present invention has achieved to provide an electrophotographic toner which enables to realize high color reproduction in the wide lightness range from a high lightness portion to a low lightness portion.

### EMBODIMENT TO CARRY OUT THE INVENTION

The present invention will be described in more detail.

The first embodiment of the present invention is an electrophotographic toner comprising a compound represented by Formula (X-1) (coloring agent), wherein a hue angle (H) of the toner in CIE L*a*b* color space is in the range of: 341°≦H≦351°, when a toner image formed only with the toner exhibits a maximum chroma.

Here, a hue angle (H) is defined as an angle measured starting from an axis of a* red direction to be 0° by moving in a counter clockwise direction to a target hue in L*a*b* color representation chromaticity diagram. It is calculated by: H=tan⁻¹(b*/a*). By obtaining a hue angle value, it can get the location of a target color in L*a*b* color representation chromaticity diagram. For example, when it is 90°, it is a hue of a yellow direction; and when it is 180°, it is a hue of a green direction.

Moreover, a maximum chroma is defined as a chroma obtained from a pure color among chroma exhibiting a degree of vividness of color. Chroma basically represents a distance from a center axis (an achromatic color axis) in a color space. Namely, a maximum chroma is a chroma which is located at a most remote distance from an achromatic color axis. In the present invention, a maximum chroma is possessed by a toner image formed only with a toner relating to the present invention.

The second embodiment of the present invention is an electrophotographic toner further containing a pigment having a quinacridone structure in addition to the compound represented by Formula (X-1); and the hue angle (H) of the toner in CIE L*a*b* color space is in the range of 341°≦H≦351°.

The third embodiment of the present invention is an electrophotographic toner further containing a compound represented by Formula (1) in addition to the compound represented by Formula (X-1); and the hue angle (H) of the toner in CIE L*a*b* color space is in the range of 341°≦H≦351°.

The fourth embodiment of the present invention is an electrophotographic toner containing a compound represented by Formula (X-1b); and the hue angle (H) of the toner in CIE L*a*b* color space is in the range of: 341°≦H≦351°.

In the present invention, when the hue angle is less than 341°, a brilliant color can be reproduced in a region of high lightness, while color reproducibility in a region of low lightness will be deteriorated. When the hue angle is more than 351°, color reproducibility in a region of low lightness will be improved, while it is difficult to be compatible with color reproducibility in a brilliant color in a region of high lightness.

In addition, a hue angle of a toner can be measured using a toner image formed on any white substrate (having L* value of 90 or more and C* value of 7 or less) such as paper or plastic sheet. A colorimeter “SPM 50” (made by GRETAG Ltd.) is used for measurement by adjusting an amount of toner adhesion so that L* value of a toner image is in the range of 40 to 60. The measuring conditions are: measuring light of D50; and view angle of 2°. By using a* value and b* value obtained from measurement, a hue angle (H) can be calculated from H=tan⁻¹(b*/a*).

### [Compound Represented by Formula (X-1)]

A compound represented by Formula (X-1) of the present invention (hereafter, it is also called as a compound of the present invention) will be described.

In Formula, one of Rx₁ and Rx₂ represents a methyl group or an ethyl group, and another one of Rx₁ and Rx₂ represents an alkyl group having 12 or less carbon atoms which may be substituted with an oxygen-containing group; or Rx₁ and Rx₂ represent a 5- or 6-membered aliphatic ring which may be substituted with an oxygen-containing group by combining Rx₁ and Rx₂ with a nitrogen atom. Examples of an alkyl group having 12 or less carbon atoms include: a methyl group, an ethyl group, n-propyl group, an iso-propyl group, n-butyl group, an isobutyl group, a tert-butyl group, a pentyl group, the amyl group, an isoamyl group, a hexyl group, an octyl group, a dodecyl group, a cyclopropyl group, a cyclobutyl group, a cyclopentyl group, a cyclohexyl group, and a 4-tert-butylcyclohexyl group. Preferably it is an alkyl group having 6 or less carbon atoms, and more preferably, it is an alkyl group having 4 or less carbon atoms.

When an alkyl group represented by one of Rx₁ and Rx₂ is substituted with an oxygen-containing group, an oxygen atom may be contained in a form of a hydroxyl group. It may be contained between a carbon atom and a carbon atom, or in a form of a carbonyl group which is formed by substituting two hydrogen atoms on a carbon atom in a main chain. Preferably, an oxygen atom is contained between a carbon atom and a carbon atom. When an oxygen atom is contained, the number of oxygen atoms may be one or two or more. When Rx₁ and Rx₂ represent a 5- or 6-membered aliphatic ring which may be substituted with an oxygen-containing group by combining Rx₁ and Rx₂ with a nitrogen atom, examples of a formed ring include: a pyrimidine ring, a morpholine ring, and a pyrrolidine ring. These rings may have further a substituent. An example of a substituent is cited a synonymous group with an alkyl group having 12 or less carbon atoms which may be substituted with an oxygen-containing group.

As an alkyl group represented by GX₂ which may be substituted with an oxygen-containing group, it can be cited a synonymous group with an alkyl group having 12 or less carbon atoms which may be substituted with an oxygen-containing group. Preferably, it is an alkyl group having 1 to 5 carbon atoms. More preferably, it is a methyl group or an ethyl group, and still more preferably, it is a methyl group.

[Compound Represented by Formula (X-1b)]

A compound represented by Formula (X-1b) of the present invention will be described.

In Formula, one of Rx_{1b} and Rx_{2b} represents a methyl group or an ethyl group, and another one of Rx_{1b} and Rx_{2b} represents an alkyl group having 4 or less carbon atoms which may be substituted with an oxygen-containing group, provided that a sum of carbon atoms of Rx_{1b} and Rx_{2b} is an integer of 3 to 5, or Rx_{1b} and Rx_{2b} represents a 5- or 6-membered aliphatic ring which may be substituted with an oxygen-containing group by combining Rx_{1b} and Rx_{2b} with a nitrogen atom.

Examples of Rx_{1b} and Rx_{2b} include: a methyl group, an ethyl group, an n-propyl group, an isopropyl group, an n-butyl group, an isobutyl group, and a tert-butyl group. When an alkyl group represented by one of Rx_{1b} and Rx_{2b} is substituted with an oxygen-containing group, an oxygen atom may be contained in a form of a hydroxyl group as a terminal group. It may be contained between carbon atoms in a main chain. Preferably, an oxygen atom is contained between carbon atoms in a main chain. When an oxygen atom is contained, the number of oxygen atoms may be one or two or more. Specific examples thereof are: a hydroxyethyl group, 1-hydroxypropyl group, 2-hydroxypropyl group, a methoxyethyl group, an ethoxyethyl group, and a methoxypropyl group. It is preferable that one of Rx_{1b} and Rx_{2b} represents a methyl group or an ethyl group, and another one of Rx_{1b} and Rx_{2b} represents an alkyl group having 4 or less carbon atoms which may be substituted with an oxygen-containing group, provided that a sum of carbon atoms of Rx_{1b} and Rx_{2b} is an integer of 3 to 5. As described above, it is preferable that a sum of carbon atoms of Rx_{1b} and Rx_{2b} is an integer of 3 to 5, more preferably, an integer of 3 or 4, and most preferably, it is an integer of 3.

[Specific Examples of a Compound Represented by Formula (X-1) or Formula (X-1b)]

Specific examples of a compound represented by Formula (X-1) or Formula (X-1b) are shown below, however, the present invention will not be limited to these.

| Compound | | | |
|---|---|---|---|
| number | Rx₁ or Rx_{1b} | Rx₂ or Rx_{2b} | GX₂ |
| MX - 1 | —CH₃ | —CH₃ | —CH₃ |
| MX - 2 | —CH₃ | —C₂H₅ | —CH₃ |
| MX - 3 | —CH₃ | —C₃H₇(n) | —CH₃ |
| MX - 4 | —CH₃ | —C₃H₇(i) | —CH₃ |
| MX - 5 | —CH₃ | —C₄H₉(n) | —CH₃ |
| MX - 6 | —CH₃ | —C₄H₉(i) | —CH₃ |
| MX - 7 | —CH₃ | —C₄H₉(t) | —CH₃ |
| MX - 8 | —CH₃ | —C₂H₄—OH | —CH₃ |
| MX - 9 | —CH₃ | —C₂H₄—O—CH₃ | —CH₃ |
| MX - 10 | —CH₃ | —(C₂H₄—O)₂—CH₃ | —CH₃ |
| MX - 11 | —CH₃ | —C₂H₄—O—C₂H₄—OH | —CH₃ |
| MX - 12 | —CH₃ | —CH₂—CH(—OH)—CH₃ | —CH₃ |
| MX - 13 | —CH₃ | —C₆H₁₃(n) | —CH₃ |
| MX - 14 | —CH₃ | —C₈H₁₇(n) | —CH₃ |
| MX - 15 | —CH₃ | —C₁₂H₂₅(n) | —CH₃ |
| MX - 16 | —CH₃ | —CH₂—CH(—C₂H₅)—C₄H₉(n) | —CH₃ |
| MX - 17 | —CH₃ | —C₂H₅ | —C₂H₅ |
| MX - 18 | —CH₃ | —C₂H₅ | —C₂H₄—O—CH₃ |
| MX - 19 | —CH₃ | —C₂H₄—COOCH₃ | —CH₃ |
| MX - 20 | —CH₃ | —C₂H₄—COOH | —CH₃ |
| MX - 21 | —CH₃ | —C₂H₃(CH₃)—COOH | —CH₃ |
| MX - 22 | —CH₃ | —CH₃ | —C₂H₄—O—CH₃ |
| MX - 23 | —CH₃ | —CH₃ | —CH₂—CH(—OCH₃)—CH₃ |
| MX - 24 | —C₂H₅ | —C₂H₅ | —CH₃ |
| MX - 25 | —C₂H₅ | —C₃H₇(n) | —CH₃ |
| MX - 26 | —C₂H₅ | —C₃H₇(i) | —CH₃ |
| MX - 27 | —C₂H₅ | —C₄H₉(n) | —CH₃ |
| MX - 28 | —C₂H₅ | —C₄H₉(i) | —CH₃ |
| MX - 29 | —C₂H₅ | —C₂H₄—OH | —CH₃ |
| MX - 30 | —C₂H₅ | —C₂H₄—O—CH₃ | —CH₃ |
| MX - 31 | —C₂H₅ | —CH₂—CH(—OH)—CH₃ | —CH₃ |
| MX - 32 | —C₂H₅ | —C₂H₄—O—CH₃ | —C₂H₅ |
| MX - 33 | —C₂H₅ | —C₅H₁₁(n) | —CH₃ |
| MX - 34 | —C₂H₅ | —C₂H₄—O—CH₃ | —CH₃ |
| MX - 35 | —C₂H₅ | —C₁₀H₂₁(n) | —CH₃ |
| MX - 36 | —C₂H₅ | —CH₃ | —C₆H₁₃(n) |
| MX - 37 | —C₂H₅ | —CH₃ | —C₄H₉(t) |
| MX - 38 | —CH₃ | —CH₃ | —C₁₂H₂₅(n) |
| MX - 39 | —CH₃ | —C₂H₄—COOC₂H₅ | —CH₃ |
| MX - 40 | —C₂H₅ | —C₂H₃(CH₃)—COOCH₃ | —CH₃ |

| | | |
|---|---|---|
| MX - 41 | —(CH₂)₄— | —CH₃ |
| MX - 42 | —(CH₂)₅— | —CH₃ |
| MX - 43 | —(CH₂)₂—O—(CH₂)₂— | —CH₃ |
| MX - 44 | —(CH₂)₂—O—(CH₂)₂— | —C₂H₅ |
| MX - 45 | —(CH₂)₄— | —C₂H₄—O—CH₃ |
| MX - 46 | —(CH₂)₅— | —C₃H₇(i) |
| MX - 47 | —(CH₂)₂—O—(CH₂)₂— | —C₅H₁₁(n) |
| MX - 48 | —(CH₂)₄— | —CH₂—CH(—C₂H₅)—C₄H₉(n) |
| MX - 49 | —(CH₂)₅— | —C₂H₅ |
| MX - 50 | —(CH₂)₂—CH(—C₄H₉(t))—(CH₂)₂— | —CH₃ |
| MX - 51 | —(CH₂)₄— | —C₁₀H₂₁(n) |

The compounds represented by Formula (X-1) of the present invention can be synthesized by referring to the known methods described, for example, in the following publications: JP-A Nos. 63-226653, 10-193807, 11-78258, 6-250357, 2-155693, 1-110565, 2-668, 2-28264, 2-53865, and 2-53866; British patent No. 1,252,418; JP-A Nos. 64-63194, 2-208094, 3-205189, 2-265791, 2-310087, 2-53866, 4-91987, 63-205288 and 3-226750; British patent No. 1,183,515; JP-A Nos. 4-190348, 63-113077, 3-275767, 4-13774, 4-89287, 7-175187, 10-60296, 11-78258, 2004-138834, and 2006-350300.

Examples of a synthetic method of a specific compound of the present invention represented by Formula (X-1) are shown in the following, however, other compounds can be also synthesized in the same manner. The synthetic methods are not limited to these.

### Synthetic Example 1

### Synthesis of Exemplified Compound (MX-2)

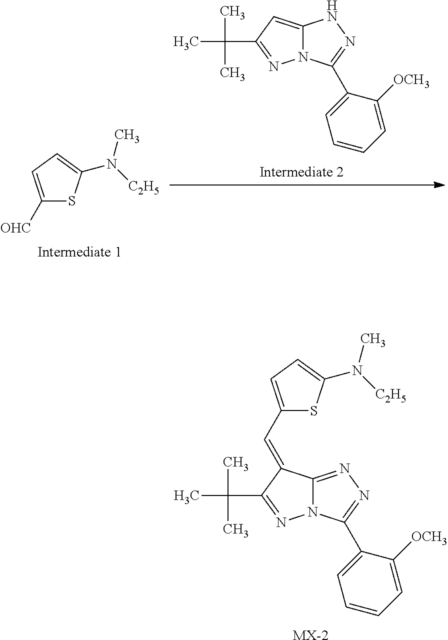

To 2.0 g of Intermediate 1 and 2.9 g of Intermediate 2 were added 50 ml of toluene and 0.35 g of morpholine with stifling. The mixture was heated to reflux, and it was allowed to react for 8 hours while dehydrating by an esterification tube. After termination of the reaction, the reaction liquid was condensed. Then it was purified with column chromatography, and recrystallized from a mixed solvent of ethyl acetate and hexane. Thus, 3.5 g of MX-2 was obtained. It was confirmed that the obtained compound was the targeted compound by MASS, ¹H-NMR and IR spectrum.

Measurement of visible light absorption spectrum (solvent: ethyl acetate): maximum absorption wavelength 525 nm, molar extinction coefficient 58,000 (L/mol·cm); and melting point 188-190° C.

### Synthetic Example 2

### Synthesis of Exemplified Compound (MX-3)

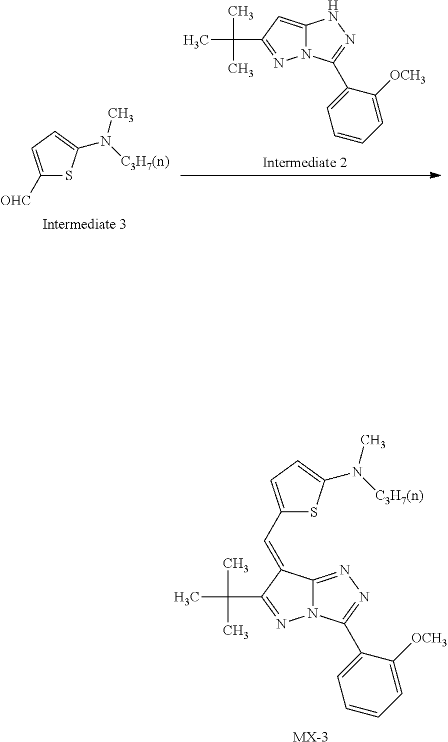

MX-3 was obtained in the same manner as Synthetic example 1 except that Intermediate 1 was changed with Intermediate 3.

Measurement of visible light absorption spectrum (solvent: ethyl acetate): maximum absorption wavelength 526 nm, molar extinction coefficient 55,000 (L/mol·cm).

### Synthetic Example 3

### Synthesis of Exemplified Compound (MX-4)

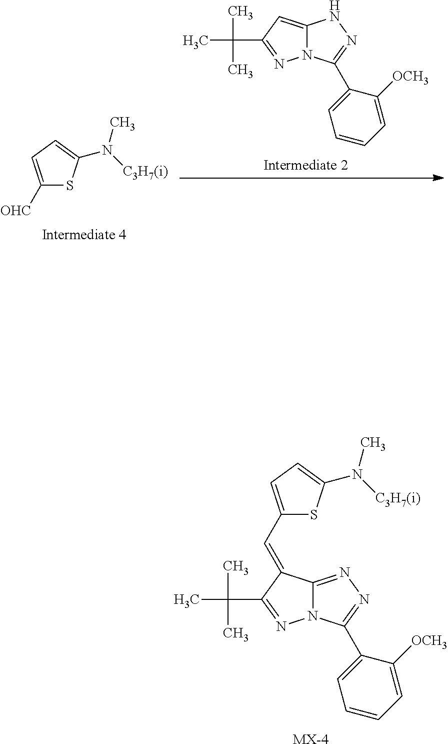

MX-4 was obtained in the same manner as Synthetic example 1 except that Intermediate 1 was changed with Intermediate 4.

Measurement of visible light absorption spectrum (solvent: ethyl acetate): maximum absorption wavelength 526 nm, molar extinction coefficient 50,000 (L/mol·cm).

### Synthetic Example 4

### Synthesis of Exemplified Compound (MX-8)

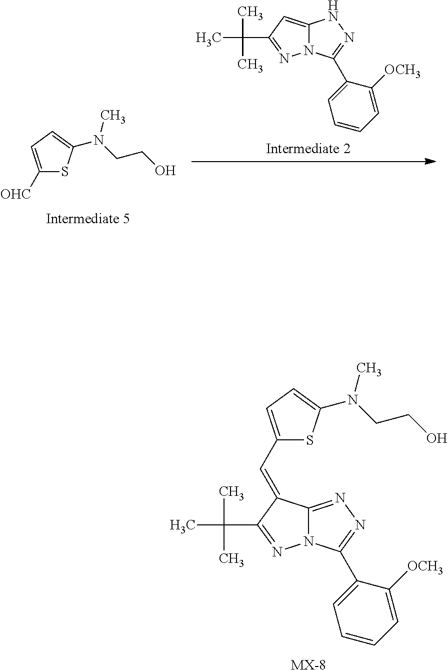

MX-8 was obtained in the same manner as Synthetic example 1 except that Intermediate 1 was changed with Intermediate 5.

Measurement of visible light absorption spectrum (solvent: ethyl acetate): maximum absorption wavelength 527 nm, molar extinction coefficient 55,500 (L/mol·cm).

### Synthetic Example 5

### Synthesis of Exemplified Compound (MX-9)

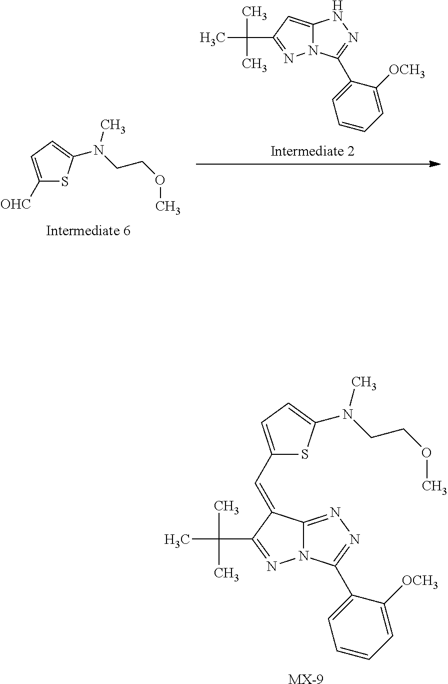

MX-9 was obtained in the same manner as Synthetic example 1 except that Intermediate 1 was changed with Intermediate 6.

Measurement of visible light absorption spectrum (solvent: ethyl acetate): maximum absorption wavelength 524 nm, molar extinction coefficient 55,700 (L/mol·cm).

### Synthetic Example 6

### Synthesis of Exemplified Compound (MX-24)

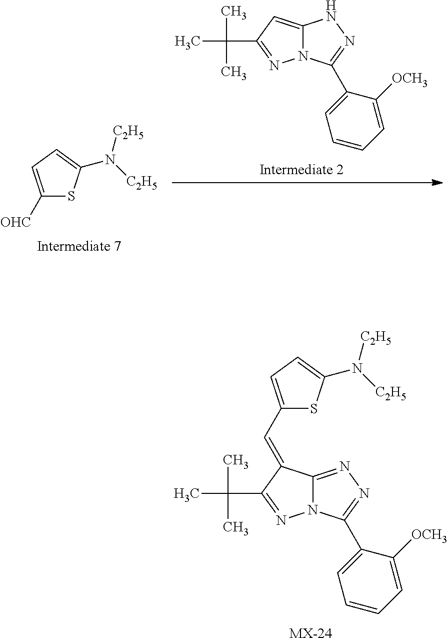

MX-24 was obtained in the same manner as Synthetic example 1 except that Intermediate 1 was changed with Intermediate 7.

Measurement of visible light absorption spectrum (solvent: ethyl acetate): maximum absorption wavelength 528 nm, molar extinction coefficient 63,000 (L/mol·cm); and melting point 155-156° C.

### Synthetic Example 7

### Synthesis of Exemplified Compound (MX-41)

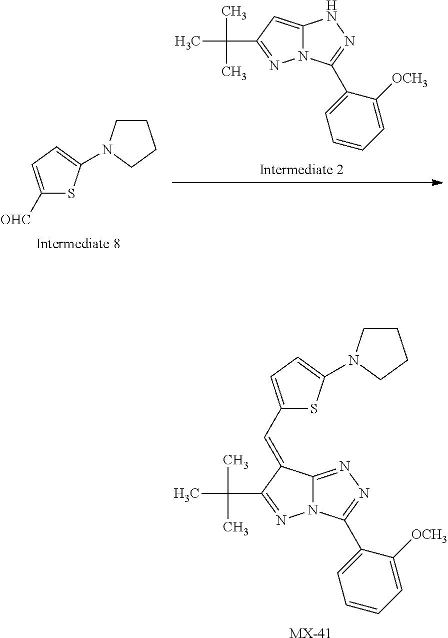

MX-41 was obtained in the same manner as Synthetic example 1 except that Intermediate 1 was changed with Intermediate 8.

Measurement of visible light absorption spectrum (solvent: ethyl acetate): maximum absorption wavelength 528 nm, molar extinction coefficient 56,000 (L/mol·cm).

### Synthetic Example 8

### Synthesis of Exemplified Compound (MX-42)

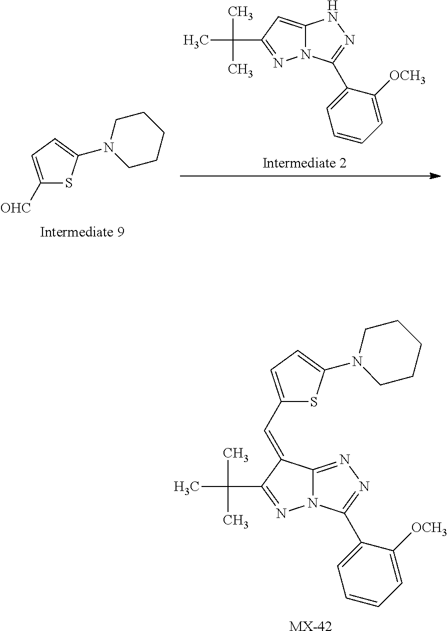

MX-42 was obtained in the same manner as Synthetic example 1 except that Intermediate 1 was changed with Intermediate 9.

Measurement of visible light absorption spectrum (solvent: ethyl acetate): maximum absorption wavelength 519 nm.

### Synthetic Example 9

### Synthesis of Exemplified Compound (MX-43)

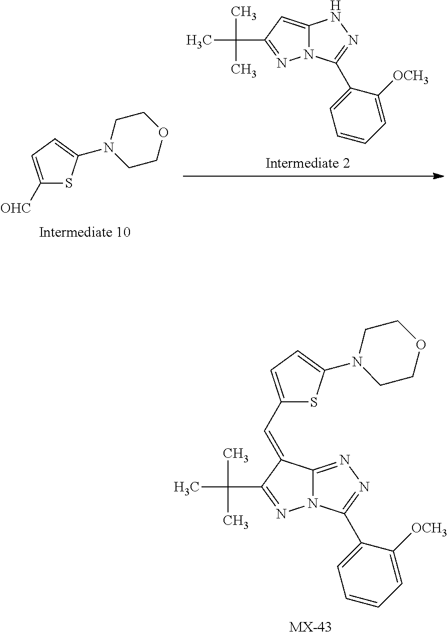

MX-43 was obtained in the same manner as Synthetic example 1 except that Intermediate 1 was changed with Intermediate 10.

Measurement of visible light absorption spectrum (solvent: ethyl acetate): maximum absorption wavelength 499 nm, molar extinction coefficient 48,000 (L/mol·cm).

### [Pigment Having a Quinacridone Structure]

A pigment having a quinacridone structure will be described in the following.

As a pigment having a quinacridone structure, it is preferable a compound having the following structure.

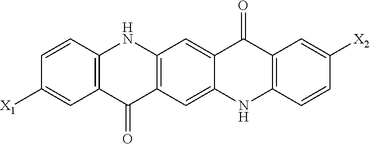

(In the formula, X₁ and X₂ each are one selected from the group consisting of a hydrogen atom, an alkyl group, an alkoxy group and a halogen atom.)

Examples of a pigment having a quinacridone structure include quinacridone compounds. Specific examples thereof are: C. I. Pigment Red 122, 192, 202, 207, 209 and C. I. Pigment Violet 19.

### [Metal-Containing Compound Represented by Formula (1)]

Then, it will be described a metal-containing compound represented by Formula (1).

First, the structure represented by the afore-mentioned Formula (1) will be described.

Formula (1) of the present invention can be described by the canonical Formulas (1a) and (1b). In the present invention, Formulas (1a) and (1b) are intrinsically identical, and they cannot be distinguished with each other. Here, discrimination of a covalent bond (shown by “-”) and a coordinate bond (shown by “ . . . ”) are done for form's sake, they do not represent an absolute difference.

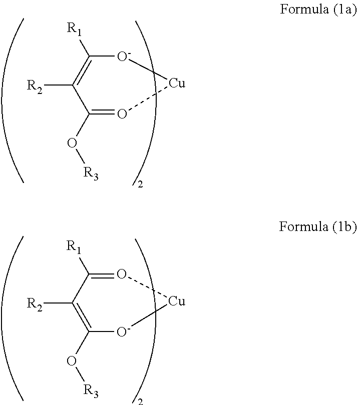

It is preferable that the metal-containing compounds of the present invention are obtained by synthesizing the compound represented by the following Formula (1-2) at first, then by allowing to react a bivalent metal compound with these compounds. The synthetic method of these metal-containing compounds can be referred to the method described in “Chelate chemistry (5): Complex Compound Chemistry Experimental Method [I] (edited by Nankodo Publisher)”. As a bivalent metal compound used, it can be cited: copper (II) chloride, copper (II) acetate and copper perchlorate. Moreover, the metal-containing compound used for the present invention may have a neutral ligand according to a central metal, and H₂O or NH₃ are cited as a typical ligand.

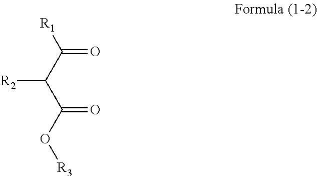

In Formula (1), Formula (1a), Formula (1b), Formula (1-2), R₁ represents an alkyl group (for example, a methyl group, an ethyl group, a propyl group, an isopropyl group, a tert-butyl group, a pentyl group, a hexyl group, an octyl group, a dodecyl group. a tridecyl group, a tetradecyl group, a pentadecyl group, a cyclopentyl group and a cyclohexyl group). These groups may further have a substituent.

Examples of a substituent which can be substituted to R₁ include: an alkyl group (for example, a methyl group, an ethyl group, a propyl group, an isopropyl group, a tert-butyl group, a pentyl group, a hexyl group, an octyl group, a dodecyl gorup, a tridecyl group, a tetradecyl group, a pentadecyl group, a cyclopentyl group, and a cyclohexyl group); an alkenyl group (for example, a vinyl group and an allyl group); an alkynyl group (for example, an ethynyl group and a propargyl group); an aryl group (for example, a phenyl group and a naphthyl group); a hetero aryl group (for example, a furyl group, a thienyl group, a pyridyl group, a pyridazyl group, a pyrimidinyl group, a pyrazyl group, a triazyl group, an imidazolyl group, a pyrazolyl group, a triazolyl group, a benzoimidazolyl group, a benzoxazolyl group, a quinazolinyl group, and a phthalazinyl group); a heterocyclic group (for example, a pyrrolidyl group, an imidazolidyl group, a morpholyl group, and an oxazolidyl group); an alkoxyl group (for example, a methoxy group, an ethoxy group, a propyloxy group, a pentyloxy group, an hexyloxy group, an oxtyloxy group, and a dodecyloxy group, a cyclopentyloxy group, and a cyclohexyloxy group); an aryloxy group (for example, a phenoxy group and a naphthyloxy group); an alkylthio group (for example, a methylthio group, an ethylthio group, a propylthio group, a pentylthio group, a hexylthio group, an octylthio group, a dodecylthio group, a cyclopentylthio group, and a cyclohexylthio group); an arylthio group (for example, a phenylthio group and a naphthylthio group); an alkoxycarbonyl group (for example, a methyloxycarbonyl group, an ethyloxycarbonyl group, a butyloxycarbonyl group, an octyloxycarbonyl group, and a dodecyloxycarbonyl group); an aryloxycarbonyl group (for example, a phenyloxycarbonyl group and a naphthyloxycarbonyl group); a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, and a 2-pyridylaminosulfonyl group); an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group, and a pyridylcarbonyl group); an acyloxy group (for example, an acetyloxy group, an ethylcarbonyloxy group, a butylcarbonyloxy group, an octylcarbonyloxy group, a dodecylcarbonyloxy group, and a phenylcarbonyloxy group); an amido group (for example, a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcarbonylamino group, a phenylcarbonylamino group, and a naphthylcarbonylamino group); a carbamoyl group (for example, an aminocarbonyl group, a methylaminocarbonyl group, a dimethylaminocarbonyl group, a propylaminocarbonyl group, a pentylaminocarbonyl group, a cyclohexylaminocarbonyl group, an octylaminocarbonyl group, a 2-ethylhexylaminocarbonyl group, a dodecylaminocarbonyl gropup, a phenylaminocarbonyl group, a naphthylaminocarbonyl group, and a 2-pyridylaminocarbonyl group); a ureido group (for example, a methylureido group, an ethylureido group, a pentylureido group, a cyclohexylureido group, an octylureido group, a dodecylureido group, a phenylureido group, a naphthylureido group, and a 2-pyridylaminoureido group); a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group, and a 2-pyridylsulfinyl group); an alkylsulfonyl group (for example, a methylsulfonyl group, an ethylsulfonyl group, a butylsulfonyl group, a cyclohexylsulfonyl group, a 2-ethylhexylsulfonyl group, and a dodecylsulfonyl group); an arylsulfonyl group (for example, a phenylsulfonyl group, a naphthylsulfonyl group, and a 2-pyridylsulfonyl group); an amino group (for example, an amino group, an ethylamino group, a dimethylamino group, a butylamino group, a cyclopentylamino group, a dodecylamino group, an anilino group, a naphthylamino group, and a 2-pyridylamino group); a cyano group; a nitro group; and a halogen atom (for example, a chlorine atom, a bromine atom, a fluorine atom, and a iodine atom). These substituents may be further substituted with the above-mentioned substituent.

A preferable R₁ is an alkyl group of 1 to 4 carbon atoms, it is preferable to be a straight chain structure, more preferably, it is a methyl group or an ethyl group, and still more preferably, it is a methyl group.

R₂ represents a hydrogen atom, an alkoxycarbonyl group, an aryloxycarbonyl group, a sulfamoyl group, a sulfinyl group, an alkylsulfonyl group, an arylsulfonyl group, an acyl group, a halogen atom, or a cyano group. As specific examples of these groups, there are cited the synonymous groups among the substituents which can substitute to R₁.

A preferable R₂ is an alkoxycarbonyl group, an alkylsulfonyl group, an arylsulfonyl group, an acyl group, or a cyano group. More preferably, it is an alkoxycarbonyl group, an acyl group, or a cyano group. Still more preferably, it is a cyano group.

R₃ represents a group containing an aromatic hydrocarbon structure having 9 or more carbon atoms.

A group of 9 or more carbon atoms and having an aromatic hydrocarbon structure of the present invention indicates a group having a sum of the carbon atoms of 9 or more, and the group containing an aromatic hydrocarbon structure indicates a group having a sum of the carbon atoms of 9 or more in R₃ and containing an aromatic hydrocarbon structure at an arbitrary locations in R₃. An example of an aromatic hydrocarbon structure is an aryl group (for example, a phenyl group and a naphthyl group). For example, when an aromatic hydrocarbon structure is a phenyl group, R₃ is formed with an arbitrary group of 3 or more carbon atoms. In this case, 3 or more groups having a sum of carbon number of 1 can be combined to form R₃, or a group having a sum of carbon number of 1 and a group having a sum of carbon number of 2 can be combined to form R₃. The sum of carbon number in R₃ is preferably from 9 to 40, more preferably, it is from 12 to 40, and still more preferably, it is from 14 to 30.

A preferable R₃ is represented by the following Formula (3).

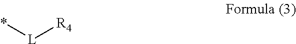

In Formula (3), L represents a divalent linking group selected from the group consisting of an alkylene group of 1 to 5 carbon atoms, —SO₂O—, —OSO₂—, —CO—, —O—, —S—, —SO₂NH—, —NH SO₂—, —CONH—, —NHCO—, —COO— and —OOC—, or a group formed by a combination thereof. At the position of (*), L links to an oxygen atom adjacent to R₃ in Formula (1).

L may have a substituent. Examples of the aforesaid substituent are the synonymous groups which can substitute to R₁ in Formula (1).

A preferable divalent linking group represented by L is an alkylene group or a group containing an alkylene group. The group containing an alkylene group indicates a divalent linking group which contains an alkylene group at an arbitrary position. Specific examples thereof include an alkylene group and a divalent linking group selected from the group consisting of an alkylene group of 1 to 5 carbon atoms, —SO₂O—, —OSO₂—, —SO₂—, —CO—, —O—, —S—, —SO₂NH—, —NH SO₂—, —NHCO—, —COO— and —OOC—, or a group made by combination of a plurality of the divalent linking groups which contains an alkylene group.

R₄ represents an aryl group (for example, a phenyl group or a naphtyl group).

Although specific examples of the divalent linking group represented by L are shown below, the present invention is not limited to them.

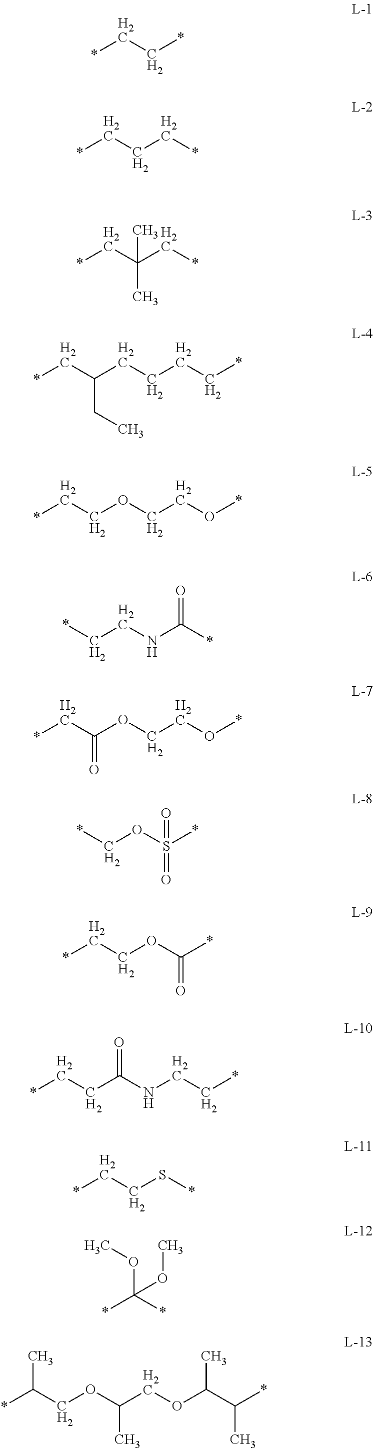

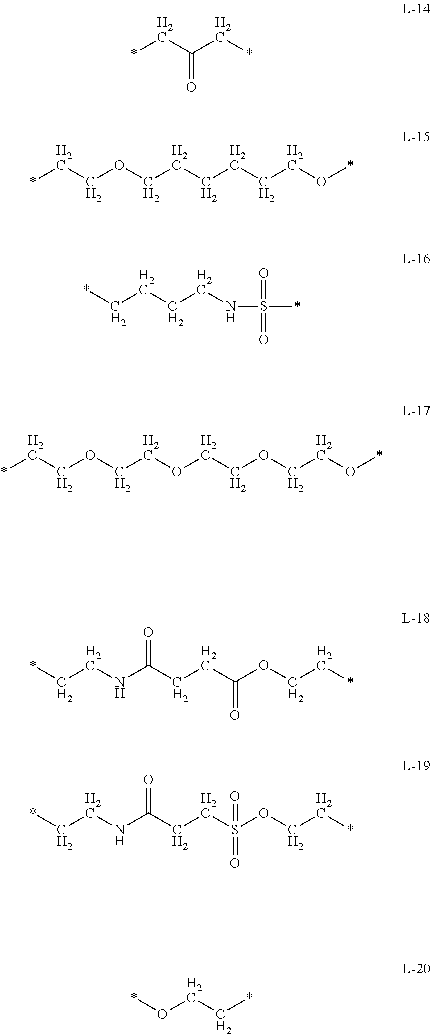

L links to an oxygen atom adjacent to R₃ in Formula (1) or links to R₄ at the positions of“*”.

R₄ represents an aryl group (for example, a phenyl group and a naphtyl group).

R₃ and R₄ may have a substituent. Examples of the aforesaid substituent are the synonymous groups which can substitute to R₁ in Formula (1).

Preferable substituents which are substituted to L, R₃ and R₄ include: an alkyl group, an alkoxyl group, an aryloxy group, an alkylthio group, an aryl thio group, an alkoxycarbonyl group, an aryloxycarbonyl group, a sulfamoyl group, an acyl group, an acyloxy group, an amide group, a carbamoyl group, an alkyl sulfonyl group, an arylsulfonyl group, an amino group, a cyano group, a nitro group and a halogen atom. More preferable substituents are: an alkyl group, an alkoxyl group, an aryloxy group, an alkoxycarbonyl group, an aryloxycarbonyl group, a sulfamoyl group, an acyl group, an acyloxy group, an amide group and a carbamoyl group. And especially preferable substituents are: an alkyl group, an alkoxyl group, an aryloxy group, an alkoxycarbonyl group, an acyloxy group and an amide group.

R₄ is preferably a phenyl group, and more preferably, a phenyl group having a substituent More preferably, R₄ is a phenyl group having a substituent of: an alkyl group, an alkoxyl group, an aryloxy group, an alkoxycarbonyl group, an acyloxy group, or an amide group. Still more preferably, R₄ is a phenyl group having an alkyl group or an alkoxyl group.

R₃ or Formula (3) is preferably a group represented by the following Formula (3-2).

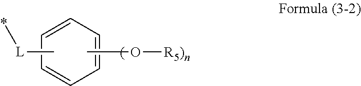

In Formula (3-2), L and “*” each represent the synonymous groups of L and “*” in Formula (3). R₅ represents an alkyl group of 8 to 30 carbon atoms. “n” is an integer of 1 to 3.

More preferably, R₅ represents an alkyl group of 12 to 24 carbon atoms, and more preferably, R₅ represents an alkyl group of 16 to 24 carbon atoms. R₅ may have a substituent. Examples of the aforesaid substituent are the synonymous groups which can substitute to R₁ in Formula (1). R₅ is preferably a strait chain alkyl group and it is more preferable that the strait chain alkyl group is consisted of carbon atoms and hydrogen atoms.

“n” is preferably an integer of 1 or 2. Most preferably, “n” is an integer of 1.

Specific examples of the metal-containing compound represented by Formula (1) are shown, however, the present invention is not limited to them. The symbol “*” in tables indicates the linking place of each group.

| Com- | | | |
|---|---|---|---|
| pound | | | |
| num- | | | |
| ber | R₁ | R₂ | R₃ |
| 1 | CH₃—* | 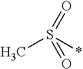 [SMILES: *S(C)(=O)=O] | 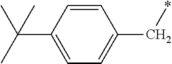 [SMILES: *Cc1ccc(C(C)(C)C)cc1] |
| 2 | CH₃—* | NC—* | 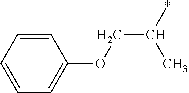 [SMILES: *C(C)COc1ccccc1] |
| 3 | CH₃—* | NC—* | 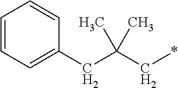 [SMILES: *CC(C)(C)Cc1ccccc1] |
| 4 | CH₃—* | 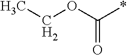 [SMILES: *C(=O)OCC] | 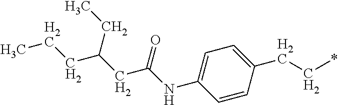 [SMILES: *CCc1ccc(NC(=O)CC(CC)CCC)cc1] |
| 5 | CH₃—* | NC—* | 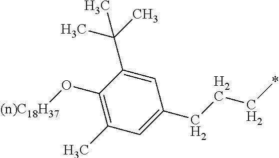 |
| 6 | CH₃—* | 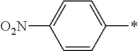 [SMILES: *c1ccc([N+](=O)[O-])cc1] | 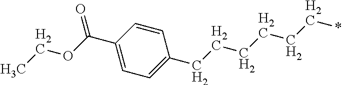 [SMILES: *CCCCCCc1ccc(C(=O)OCC)cc1] |
| 7 | CH₃—* | NC—* | 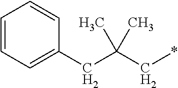 [SMILES: *CC(C)(C)Cc1ccccc1] |
| 8 | CH₃—* | NC—* | 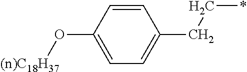 |
| 9 | CH₃—* | 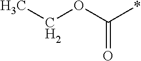 [SMILES: *C(=O)OCC] | 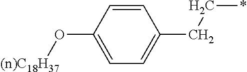 |
| 10 | CH₃—* | 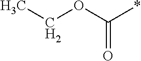 [SMILES: *C(=O)OCC] | 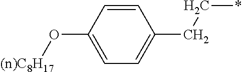 |
| 11 | CH₃—* | NC—* | 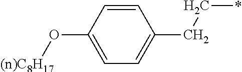 |
| 12 | CH₃—* | NC—* | 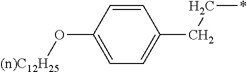 |
| 13 | CH₃—* | NC—* | 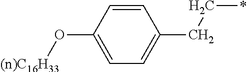 |
| 14 | CH₃—* | 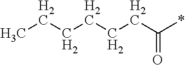 [SMILES: *C(=O)CCCCCC] | 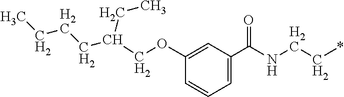 [SMILES: *CCNC(=O)c1cccc(OCC(CC)CCCC)c1] |
| 15 | CH₃—* | NC—* | 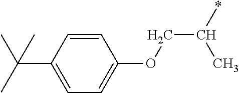 [SMILES: *C(C)COc1ccc(C(C)(C)C)cc1] |
| 16 | CH₃—* | NC—* | 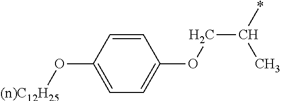 |
| 17 | C₂H₅—* | 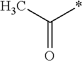 [SMILES: *C(C)=O] | 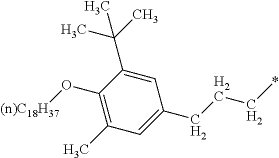 |
| 18 | C₂H₅—* | NC—* | 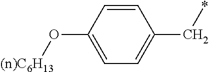 |
| 19 | CH₃—* | NC—* | 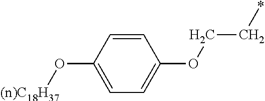 |
| 20 | C₂H₅—* | 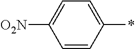 [SMILES: *c1ccc([N+](=O)[O-])cc1] | 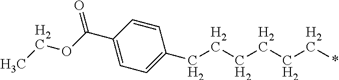 [SMILES: *CCCCCCc1ccc(C(=O)OCC)cc1] |
| 21 | CH₃—* | NC—* | 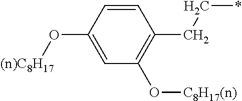 |
| 22 | (CH₃)₂CH—* | 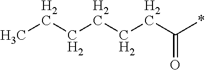 [SMILES: *C(=O)CCCCCC] | 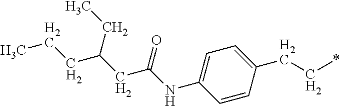 [SMILES: *CCc1ccc(NC(=O)CC(CC)CCC)cc1] |
| 23 | (CH₃)₃CH—* | 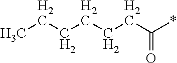 [SMILES: *C(=O)CCCCCC] | 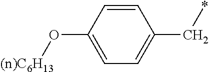 |
| 24 | CH₃—* | NC—* | 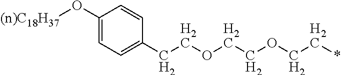 |
| 25 | CH₃—O—C₂H₄—* | 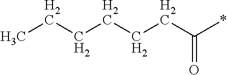 [SMILES: *C(=O)CCCCCC] | 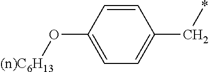 |
| 26 | 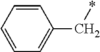 [SMILES: *Cc1ccccc1] | NC—* | 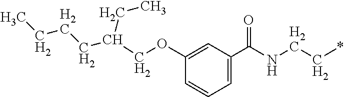 [SMILES: *CCNC(=O)c1cccc(OCC(CC)CCCC)c1] |
| 27 | 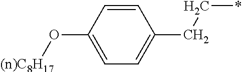 | NC—* | 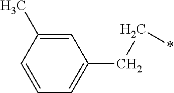 [SMILES: *CCc1cccc(C)c1] |
| 28 | CH₃—* | 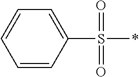 [SMILES: *S(=O)(=O)c1ccccc1] | 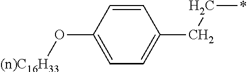 |
| 29 | CH₃—* | 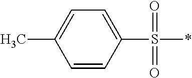 [SMILES: *S(=O)(=O)c1ccc(C)cc1] | 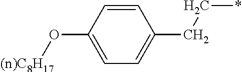 |
| 30 | CH₃—* | NC—* | 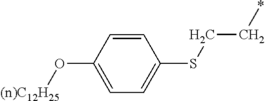 |
| 31 | CH₃—* | NC—* | 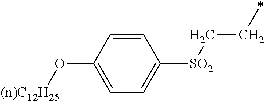 |
| 32 | CH₃—* | NC—* | 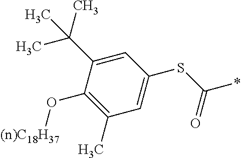 |
| 33 | CH₃—* | NC—* | 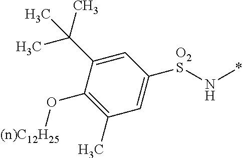 |
| 34 | CH₃—* | NC—* | 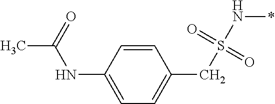 [SMILES: *NS(=O)(=O)Cc1ccc(NC(C)=O)cc1] |
| 35 | C₂H₅—* | NC—* | 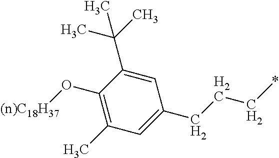 |
| 36 | CH₃—* | NC—* | 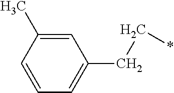 [SMILES: *CCc1cccc(C)c1] |
| 37 | CH₃—* | 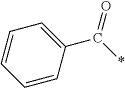 [SMILES: *C(=O)c1ccccc1] | 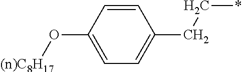 |
| 38 | (n)C₄H₉—* | NC—* | 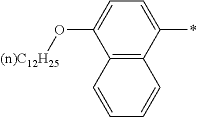 |
| 39 | 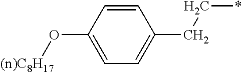 | NC—* | 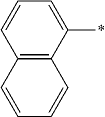 [SMILES: *c1cccc2ccccc12] |
| 40 | CH₃—* | NC—* | 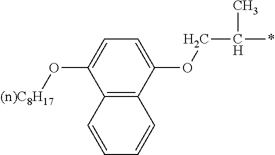 |
| 41 | CH₃CH₂C(CH₃)₂—* | H—* | 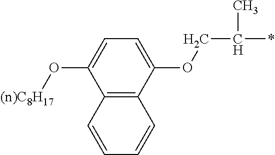 |
| 42 | CH₃—* | 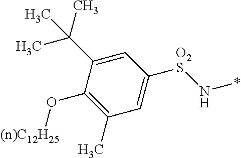 | 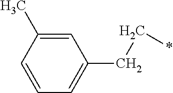 [SMILES: *CCc1cccc(C)c1] |
| 43 | 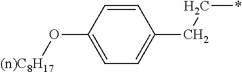 | Cl—* | 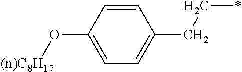 |
| 44 | CH₃—* | Br—* | 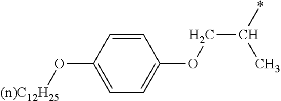 |
| 45 | CH₃—* | CH₃—O—C(═O)—* | 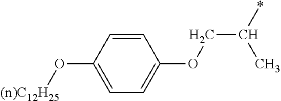 |
| 46 | CH₃—* | CH₃—S(═O)—* | 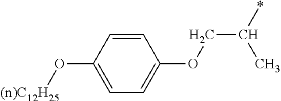 |
| 47 | CH₃—* | C₆H₅—O—C(═O)—* | 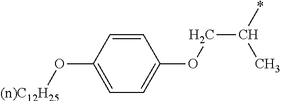 |

The electrophotographic toner of the invention will be described in the following.

### [Dispersing Method of Coloring Agent]

The electrophotographic toner of the invention can be produced by the following methods in which a dye dispersion liquid is directly dispersed in a binder resin, or mixed with a coloring agent particle dispersion and a later-mentioned desired additive is added, and then the resulted material is subjected to various methods such as a knead-crashing method, suspension polymerization method, emulsion polymerization method, emulsifying dispersion particle producing method and encapsulating method. Among these methods, the emulsion polymerization method is preferred from the viewpoint of the cost and the production stability of the producing when the particle size reducing for rising in the image quality is considered. In the emulsion polymerization method, a thermoplastic resin emulsion prepared by emulsion polymerization is mixed with a dispersion of toner particle component such as a dispersion of solid particles of dye and particles are formed by controlling pH. The resultant particles are gradually associated while taking balance between the repulsion force of the surface of formed particle and the coagulating force caused by the addition of electrolyte. The association is carried out while controlling the size and shape of the particle and the inter-particle fission and shape of the associated particle are controlled by stirring and heating to produce the toner particle.

When the coloring agent particle dispersion is prepared by direct dispersion, the dispersion can be carried out by using commonly employed machines such as: a bead dispersing machine, a high speed stirring dispersing machine or a medium using type stirrer. The dispersion can be also prepared by the same method as used for producing the colored particle dispersion. Namely, the coloring agent is dissolved (or dispersed) in an organic solvent and emulsified in water and then the organic solvent is removed.

### [Electrophotographic Toner]

In one of the embodiments of the electrophotographic toner of the present invention, it can be used a substance including at least a colored particle dispersed in a thermoplastic resin (this substance is usually called as “colored particle”, and the colored particle added with an external additive such as silica particles is usually called as “an electrophotographic toner”). In many cases, the aforesaid colored particles incorporate at least a charge controlling agent and a releasing agent when required.

Further, the dispersed particle diameter of the coloring agent particle can be controlled by using a dispersing method such as the later-mentioned dry-in-liquid method. In the toner using the above-described coloring agent, the coloring agent particles can be dispersed in the thermoplastic resin beforehand, instead of directly dispersing or dissolving the coloring agent into a small amount of a toner binder resin. In this way, the coloring agent in the colored particle is dissolved in the resin at the level of molecule state. Accordingly, it is considered that the transparency of each of mono-color images is increased so that the transparence of overlapped color image is also improved.

In an example of preferable embodiments, the colored particle may be covered by au outer resin (shell). In such a case, combination of the resin constituting the inner portion (core) of the colored particle and the thermoplastic resin (binder resin) is not specifically limited and the degree of selection freedom of the material is made large. When the shell resins of the four color (yellow, magenta, cyan and black) toners are the same, advantage in the cost is large since the toners can be produced under the same production condition. Moreover, anxieties of the sublimation of the coloring agent and contamination of oil at the time of thermal fixing, which are generally considered as problems in toners using coloring agent, are not caused since transfer of the dye used as a coloring agent to outside of the colored particle (exposing of the dye at the surface of the colored particle) is not caused when the colored particle is covered by the shell resin.

### [Production Method of Colored Particles]

Then, an example of production method of colored particles will be described below as one of preferable embodiments of the present invention.

The colored particle of the present invention can be obtained, for example, by dissolving (or dispersing) the colorant (or colorant, resin, high-boiling solvent and additive) in an organic solvent and emulsifying in water and then removing the solvent; such method is called as the dry-in-liquid method. When the resin is added for overcoating with an outer resin (shell), a monomer having a polymerizable unsaturated double bond is added to the colored particle and emulsion polymerization is carried out in the presence of a surfactant to precipitate the resin simultaneously with polymerization. Thus colored particle having the core/shell structure can be obtained. Other than that, such colored particle can be prepared by various methods such as a method in which an aqueous dispersion of rein fine particles is previously prepared by emulsion polymerization and mixed with an organic solvent solution of the dye for impregnating the dye into the resin fine particle and then the shell is formed on the core of the colored particle.

The shell is preferably formed by an organic resin, and a method is applicable in which a resin dissolved in an organic solvent is gradually propped for simultaneously precipitating and adsorbing onto the colored particle surface. In the present invention, the method is preferable in which the colored particle containing a colorant and a resin to be used as the core is formed and then the monomer having a polymerizable unsaturated double bond is added and emulsion polymerization is carried out in the presence of the surfactant for forming the shell by precipitating the resin simultaneously with the polymerization.

Other than the above, the colorant may be dispersed in water in the presence of the surfactant by a bead dispersing machine, a high speed stirring dispersing machine or a medium using type stirrer.

### [Surfactants Usually Used]

A usual anionic emulsification agent (surfactant) and/or a nonionic emulsification agent (surfactant) can be used according to necessity on the occasion of emulsification of the colored particle as one of preferable embodiments of the invention.

As examples of nonionic surfactant, a polyoxyethylene alkyl ether such as polyoxyethylene lauryl ether and polyoxyethylene stearyl ether, a polyoxyethylene alkylphenyl ether such as polyoxyethylene nonylphenyl ether, a sorbitan higher fatty acid ester such as sorbitan monolaurate, sorbitan monostearate and sorbitan trioleate, a polyoxyethylene higher fatty acid ester such as polyoxyethylene monolaurate and polyoxyethylene monostearate, a glycerol higher fatty acid ester such as oleic monoglyceride and stearic monoglyceride and a polyoxyethylene-polyoxypropylene block copolymer are cited.

As examples of the anionic surfactant, a higher fatty acid salt such as sodium oleate, an alkylarylsulfonate such as sodium dodecylbenzenesulfonate, an alkylsulfate such as sodium laurylsulfate, a polyoxyethylene alkyl ether sulfate such as sodium polyethoxyethylene lauryl ether sulfate, a polyoxyethylene alkylaryl ether sulfate such as sodium polyoxyethylene nonylphenyl ether sulfate, a salt of alkylsulfosuccinic ester salt such as sodium monooctyl-sulfosuccinate, sodium dioctylsulfosuccinate and sodium polyoxyethylene laurylsulfosuccinate and a derivative thereof can be cited.

### [Coloring Agent]

The dyes to be used in the invention will be described below.

Generally known dyes are usable in this invention, and oil-soluble dyes are preferred and chelate dyes are more preferred. Usually, oil-soluble dyes which do not contain any water-solubilizing group such as a carboxylic acid or sulfonic acid group, are soluble in organic solvents and not soluble in water, but a dye obtained by salt-formation of a water-soluble dye with a long chain base and thereby being soluble in oil, is also included. There are known, for example, an acid dye, a direct dye and a salt formation dye of a reactive dye with a long chain amine.

Specific examples thereof are described below but are not limited to these: Valifast Yellow 4120, Valifast Yellow 3150, Valifast Yellow 3108, Valifast Yellow 2310N, Valifast Yellow 1101, Valifast Red 3320, Valifast Red 3304, Valifast Red 1306, Valifast Blue 2610, Valifast Blue 2606, Valifast Blue 1603, Oil Yellow GG-S, Oil Yellow 3G, Oil Yellow 129, Oil Yellow 107, Oil Yellow 105, Oil Scarlet 308, Oil Red RR, Oil Red OG, Oil Red 5B, Oil Pink 312, Oil Blue BOS, Oil Blue 613, Oil Blue 2N, Oil Black BY, Oil Black BS, Oil Black 860, Oil Black 5970, Oil Black 5906, Oil Black 5905, which are all available from Orient Chemical Industries Co., Ltd; Kayaset Yellow SF-G, Kayaset Yellow K-CL, Kayaset Yellow GN, Kayaset Yellow A-G, Kayaset Yellow 2G, Kayaset Red SF-4G, Kayaset Red K-BL, Kayaset Red A-BR, Kayaset Magenta 312, Kayaset Blue K-FL, which are all available from NIPPON KAYAKU CO., LTD.; FS Yellow 1015, FS Magenta 1404, FS cyan 1522, FS Blue 1504, C.I. Solvent Yellow 88, 83, 82, 79, 56, 29, 16, 14, 04, 03, 02, and 01; C.I. Solvent Red 84:1, C.I. Solvent Red 84, 218, 132, 73, 72, 51, 43, 27, 24, 18, and 01; Solvent Blue 70, 67, 44, 40, 35, 11, 02, and 01; C.I. Solvent Black 43, 70, 34, 29, 27, 22, 7, 3, and 3; C.I. Solvent Violet 3; C.I. Solvent Green 3 and 7; Plast Yellow DY352, Plast Red 8375, which are available from Arimoto Chemical Co., Ltd.; MS Yellow HD-180, MS Red G. MS Magenta HM-1450H, MS Blue HM-1384, which are available from Mitsui Chemicals, Inc.; ES Red 3001, ES Red 3002, ES Red 3003, TS Red 305, ES Yellow 1001, ES Yellow 1002, Ts Yellow 118, ES Orange 2001, ES Blue 6001, TS Turq Blue 618, which are available from Sumitomo Chemical Co., Ltd.; and MACROLEX Yellow 6G, Ceres Blue GNNEOPAN Yellow 075, Ceres Blue GN, MACROLEX Red and Violet R, which are available from Bayer AG.

Disperse dyes are also usable as an oil-soluble dye, examples thereof include C.I. Disperse Yellow 5, 42, 54, 64, 79, 82, 83, 93, 99, 100, 119, 122, 124, 126, 160, 184:1, 186, 198, 199, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; C.I. Disperse green 6:1 and 9.

In addition, cyclic methylene compounds derived from phenol, naphthol, pyrazolone and pyrazolotriazole; and azomethine dye and indoaniline dye derived from a coupler such as an open chain methylene compound are also preferably usable.

Preferable colorants as described above include: the colorants described in JP-A Nos. 03-114892, 04-62092, 04-62094, 04-82896, 05-16545, 05-177958 and 05-301470.

### [Coloring Agent Particle Diameter]

The coloring agent particle as one of preferable embodiments of the invention preferably has a volume average particle diameter of from 10 nm to 1 μm. When the volume average particle diameter is less than 10 nm, the effect of sealing the coloring agent particle in the polymer of the colored particle is lowered and the stability of the coloring agent particle tends to be degraded and the storage stability is tends to be lowered because the surface area per unit volume of the particle becomes very large. Besides, a large particle having a size exceeding 1 μm is easily precipitated in the course of fine particle production so that the stability in accumulation is lowered. Moreover, decreasing in the glossiness and considerable lowering in the transparency are caused when such particle is used to make the toner. Accordingly, the average particle diameter of the coloring agent particle is preferably from 10 nm to 1 μm, more preferably from 10 to 500 nm, and further preferably from 10 to 100 nm.

The volume average particle diameter can be determined by a dynamic light scattering method, laser diffraction method, centrifugal precipitation method, FFF method or electric sensor method. In the invention, the particle diameter is preferably determined by the dynamic light scattering method using Zetasizer, manufactured by Malvern Ltd.

### [Coloring Agent Content]

The colored particle relating to the invention preferably has a coloring agent content of from 3.0 to 20 mass %. When the coloring agent content is from 3.0 to 20 mass %, sufficient density can be obtained and the protection effect of the resin to the colorant is realized so that the storage stability of the fine particle dispersion is superior, therefore the increasing in the particle sized caused by coagulation can be prevented.

### [Content of Metal-Containing Compound]

The metal-containing compound represented by Formula (1) may be used singly or in combination of two kinds, and the total amount of the metal-containing compounds is preferably from 0.8 to 3 times of moles, and more preferably 1 to 2 times, in mole of a dye. The light fastness is considerably improved when the content is 0.8 times of moles or more, and the dispersion stability of the colored particle is raised when the content is 3 times of moles or less so that toner making can be advantageously carried out tough depending on the kind of coloring agent used in combination therewith.

### [Electrophotographic Toner]

In the electrophotographic toner of the invention, a charge controlling agent and an offset preventing agent can be added additionally to the above thermoplastic resin and the coloring agent particle. As the charge controlling agent to be used in the color toner, a colorless, white or faint color charge controlling agent which does not give bad influence on the tone and transparency of the toner can be used. For example, complexes of metals such as zinc and chromium with a derivative of salicylic acid, calixarene type compounds, organic boron compounds and fluorine-containing quaternary ammonium salt type compounds are suitably used. For example, the salicylic acid metal complexes described in JP-A Nos. 53-127726 and 62-145255, the calixarene compounds described in JP-A No. 02-201378, the organic boron compounds described in JP-A No. 02-221967 and the organic boron compounds described in JP-A No. 3-1162 are usable. When such the charge controlling agent is used, the content of it is preferably from 0.1 to 10 mass parts, and more preferably from 0.5 to 5.0, mass parts with respect to 100 mass parts of the thermoplastic resin (binder resin).

The releasing agent (offset preventing agent) is not specifically limited and polyethylene wax, oxide type polyethylene wax, Camauba wax, polypropylene wax, oxide type polypropylene wax, Sasol wax, rice wax, candelilla wax, jojoba oil wax and beeswax are usable for example. The adding amount of such the wax is desirably from 0.5 to 30 mass parts, preferably from 1 to 20 mass parts with respect to 100 mass parts of the thermoplastic (binder) resin. The effect of addition is made insufficient when the adding amount is less than 0.5 mass parts, and the transparence and color reproduction ability is lowered when the adding amount is more than 30 mass parts.

As an image stabilizing agent to improve the stability of a coloring agent, the compounds described or referred in pages 10 to 13 of JP-A No. 08-29934 may be added, and phenol type, amine type, sulfur type and phosphor type compounds available on the market are also cited. An organic and inorganic UV absorbent may be added for the same purpose. As the organic UV absorbent, a benzotriazole compound such as 2-(2′-hydroxy-5′-t-butylphenyl)benzotriazole and 2-(2′-hydroxy-3′,5′-di-t-butylphenyl)benzotriazole, a benzophenone type compound such as 2-hydroxy-4-methoxy-benzophenone and 2-hydroxy-4-n-octyloxybenzophenone, and a hydroxybenzoate compound such as phenyl salicylate, 4-t-butylphenyl salicylate, n-hexadecyl 2,5-t-butyl-4-hydroxybenzoate and 2,4-di-t-butylphenyl-3′,5′-di-t-butyl-4′-hydroxybenzoate can be cited. As the inorganic UV absorbent, titanium oxide, zinc oxide, cerium oxide, iron oxide and barium sulfate can be cited. The organic UV absorbents are preferable. The UV absorbent preferably has 50% transparent wavelength range of from 350 to 420 nm and more preferably from 360 to 400 nm. The UV cutting ability is insufficient at the wavelength of shorter than 350 nm and the coloring is increased at the wavelength of longer than 420 nm, therefore, such the UV absorbent is not preferable. The adding amount is preferably within the range of from 10 to 200 mass % of the dye is preferable and that from 50 to 150 mass % is more preferable though the adding amount is not specifically limited.

### [Binder Resins: Thermoplastic Resins]

As a binder resin (it is simply called as “a resin”) to be contained in the electrophotographic toner of the present invention, it is preferable to be selected from thermoplastic resins having high contacting ability with the coloring agent particle or the cupper complex particle, which is one of the preferable embodiments of the invention. In particular, a solvent-soluble thermoplastic resin is especially preferred. A curable resin capable of forming a three dimensional structure is usable when the precursor of the resin is solvent-soluble.

As a thermoplastic resin, one usually used for toner can be used without any limitation. Examples of the thermoplastic resin include a styrene type resin, an acryl resin such as an alkyl acrylate and alkyl methacrylate, a styrene-acryl type copolymer resin, a polyester type resin, a silicone type resin, an olefin type resin, an amide type resin and an epoxy type resin are suitably used, and the resin having high transparency, low viscosity in melted state and sharp melting property is required for raising the transparency and the color reproducibility of the overlapped image. Styrene type resin, acryl type resin and polyester resin are suitable for the resin having such the properties.

It is preferable to use a resin having the following properties for a binder resin: a number average molecular weight (Mn) of from 3,000 to 6,000, preferably from 3,500 to 5,500, a ratio of weight average molecular weight Mw to number average molecular weight Mn (Mw/Mn) of from 2 to 6, preferably from 2.5 to 5.5; a glass transition temperature of from 50 to 70° C., preferably from 55 to 70° C.; and a softening point of from 90 to 110° C., preferably from 90 to 105° C.

Fixing strength against folding is degraded and damages of the image are caused by peeling off of the toner on the occasion of folding a full color solid image when the number average molecular weight of the binder resin is less than 3,000, and the fixing strength is lowered accompanied with lowering in the thermal melting ability on the occasion of fixing when the number average molecular weight exceeds 6,000. Offset at high temperature is easily caused when Mw/Mn is less than 2, and the sharp melt ability at the time of fixing is lowered and light permeability and color mixing ability on the occasion of full color image formation is degraded when the ratio is more than 6. When the glass transition point is lower than 50° C., the heat resistivity of the toner is made insufficient and coagulation of the toner during storage tends to be caused and when the glass transition point is higher than 70° C., the toner is difficultly melted so that the fixing ability and the color mixing ability on the occasion of full color image fonnation are lowered. When the softening point is lower than 90° C., high temperature offset is easily caused and when higher than 110° C., fixing strength, light transmittance, color mixing ability and glossiness of full color image are lowered.

### [Production Method of Toner]

The electrophotographic toner of the present invention can be produced by using the above-described thermoplastic resin, colored particle and the other desirable additives, the fine particle may be a mixture of several kinds thereof or single kind for each of the particles, and by applying a method such as a knead and pulverizing method, suspension polymerization method, emulsion polymerization method, emulsified dispersion granule forming method, and capsulation method. Among these production methods, the emulsion polymerization method is preferable from the viewpoint of the cost and stability of the production considering the size down of the toner particle accompanied with the improvement of image quality.

By the polymerization method, the toner particle is produced as follows; thermoplastic resin emulsion prepared by emulsion polymerization is mixed with the dispersion of another component of toner particle such as the colored particles, and the particles are gradually coagulated while taking balance between the repulsion force of the particle surface and the coagulation force caused by the addition of electrolyte by pH control, and the fusion and shape of the particles is controlled by heating and stirring the system while controlling the diameter and distribution thereof. It is preferable from the viewpoint of high definition reproduction of image to control the volume average diameter of the electrophotographic toner particle to be from 4 to 10 μm, more preferably from 6 to 9 μm.

In the electrophotographic toner of the invention, a post treatment agent can be added and mixed for providing fluidity and improvement of cleaning suitability. As such the post treatment agent, an inorganic oxide fine particle such as a silica fine particle, an alumina fine particle and a titania fine particle, an inorganic stearic acid compound such as aluminum stearate fine particle and zinc stearate fine particle and an inorganic titanic acid compound fine particle such as strontium titanate and zinc titanate are usable. Such the fine particles may be used singly or in combination with another kind of additive. It is desirable that these fine particles are subjected to surface treatment by a silane coupling agent, titanium coupling agent, higher fatty acid or silicone oil and the adding amount of the fine particle is from 0.05 to 5 mass parts, preferably from 0.1 to 3 mass parts, with respect to 100 mass parts of the toner.

### [Developer]

An electrophotographic toner of the present invention can be used as a toner of a two-component developer together with a carrier or a one-component developer without carrier.

As the carrier for two-component developer to be combined with the electrophotographic toner of the invention, for example, a carrier composed of a particle of magnetic substance such as iron and ferrite, a resin coated carrier prepared by coating the magnetic particle with a resin and a binder type carrier prepared by dispersing the fine particles of the magnetic substance into a binder resin are usable. Among these carriers, coating resins used for a resin coated carrier are not limited in particular, preferable examples thereof include: an olefin type resin, a styrene type resin, a styrene/acrylic resin, a silicone type resin, a copolymer resin (graft resin) of organopolysiloxane and a vinyl type monomer, a fluorinated type resin and a polyester type resin from the viewpoint of toner spending, and a carrier coated with a resin formed by reacting isocyanate to the copolymer resin of organopolysiloxane and a vinyl type monomer is preferable from the viewpoint of durability, environmental stability and ant-spending property. As the above vinyl type monomer, a monomer having a substituent reactive with isocyanate such as a hydroxyl group is necessarily used. Moreover, as resins used for a binder type carrier, they are not limited in particular, and conventionally known resins can be used. Examples thereof include: a styrene/acrylic resin, a polyester type resin, a fluorinated type resin and a phenol resin. The carrier having a volume average diameter of from 20 to 100 μm, and preferably from 20 to 60 μm is preferably used from the viewpoint of securing high image quality and preventing fog. The volume average particle diameter of the carrier can be determined by a laser diffiaction particle size distribution measuring apparatus having a wet type disperser HELOS manufactured by SYMPATEC Gmbh.

### [Image Forming Method]

Then, an image forming method using with the electrophotographic toner of the present invention will be described.

The types of image forming methods are not limited in the present invention. The image forming method include, for example, a method by forming plural images are formed on the photoreceptor and collectively transferred and a method by successively transferring images formed on the photoreceptor onto an intermediate transfer belt. The method by collectively transferring plural images formed on the photoreceptor is more referable.

In this method, the image formation is carried out as follows. The photoreceptor is uniformly charged and imagewise exposed to light and then firstly developed to form the first toner image on the photoreceptor. Then the photoreceptor having the first image is uniformly charged and imagewise exposed to light corresponding to the second image and secondarily developed to form the second toner image. The photoreceptor having the first and second images is uniformly charged and imagewise exposed to light corresponding to the third image and thirdly developed to form the third toner image. Moreover, the photoreceptor having the first, second and third images is uniformly charged and imagewise exposed to light corresponding to the fourth image and fourthly developed to form the four toner image.

For example, a full color toner image is formed on the photoreceptor by carrying out the first to fourth developments by each using the yellow, magenta, cyan and black toners, respectively. After that, the image formed on the photoreceptor is collectively transferred onto an image support such as paper and fixed to the image support to obtain the image.

In this method, the images formed on the photoreceptor are collectively transferred onto the paper to form the image. Therefore, the image quality can be raised because the transfer causing disturbance of the image is carried out only at once, different from an intermediate transfer method.

As the developing method, a non-contact development is preferred since plural times of development are necessary. A method in which alternative electric field is applied on the occasion of development is also preferable.

As the above-mentioned, the non-contact developing method is preferable in the system in which a piled color image is formed on the photoreceptor and collectively transferred.

Moreover, the following method is used for improvement in the speed. A plurality of photoreceptors and developing apparatus corresponding to each color are provided; the picture images corresponding to each color are formed on the plurality of photoreceptors and they are transferred in piles on an intermediate transfer member one by one; a package transfer is carried out on an image receiving material such as paper, and a full color image is obtained. In this case, a contact developing method can be adopted as a developing mode, and both a one-component developer and a two-component developer can be adopted as a developer. This method is also called a tandem method, and since a monochrome picture and a full color image can be produced at the same printing speed by one light exposure, it is adopted with the high-speed machine.

A heat-contacting method is suitably usable as the fixing method suitably used in the present invention. As typical heat-contacting method, a heating roller fixing system and a press and heat fixing system in which fixing is carried out by a rotating roller including a heater can be cited.

### [Image After Formed]

In the course of image formation by development, transferring and fixing using the electrophotographic toner of the present invention, the coloring agent particle in the electrophotographic toner is not crushed and the state of dispersed in the toner particle is held even when the toner is transferred onto the surface of the paper.

In the present invention, the coloring agent is not released or moved on the surface of the toner particle even though the toner particle contains the coloring agent in high concentration by dispersing the coloring agent particles in the toner particles. Therefore, the following problems of the toner can be removed: (1) electric charging amount is low; (2) difference of charging amount at high temperature and high humidity condition and that at low temperature and low humidity condition is large (atmospheric dependence); and (3) the electric charging amount is fluctuated depending on the kind of pigment, for example, when the electric charging amounts of toners respectively using cyan, magenta, yellow and black pigments for full color image recording are different from each other. Moreover, there will be not produced coloring agent sublimation and oil contamination which are the problems of the toner during thermal fixing of the toner.

A transfer material is a support to hold a toner image. Usually, it is called as: transfer material; transfer body; transfer paper; or image support. Specific examples of various transfer materials are: plains paper including thin paper to thick paper; fine-quality paler; coated printing paper such as art paper and coat paper; commercially available Japanese paper; post card paper; plastic film for OHP. However, the present invention is not limited to these.

It is preferable to use a transfer material having a smooth surface in order to obtain a glossiness balance between a color image and a character image. Specifically, it is preferable a transfer material having glossiness in the range of 5 to 80. Examples thereof include: “POD 80” (glossiness: 67) made by Oji Paper Co., Ltd.), and “CF Paper” (glossiness: 5.7) made by Konica Minolta Business Technologies, Ltd.)

### EXAMPLES

Next, representative embodiments of the present invention will be shown and their effects will be described. However, it goes without saying that the present invention is not limited to these.

### <Preparation of Toner>

By employing the compounds listed in Table 1, and by using the toner preparation methods, inventive and comparative magenta toners were prepared.

### (Preparation Method 1: Pulverization Toner)

100 g of polyester resin, 6 g of solid powder of coloring agent (compound represented by Formula (X-1) relating to the present invention , or comparative coloring agent), a metal-containing compound (the added amount is listed in Table 1), a pigment having a quinacridone structure (the added amount is listed in Table 1), and 3.5 g of polypropylene resin (BISCOL 550P, made by Sanyo Kasei, Co., Ltd.) were mixed, followed by kneaded, pulverized and classified to obtain a powder. Further, 100 of this powder and 1.0 g of silica particles R805 (particle diameter: 12 nm; and hydrophobicity: 60, made by Nippon Aerosil Co., Ltd.) were mixed were mixed with a Henschel mixer to obtain a pulverization toner.

### (Preparation Method 2: Polymerization Toner)

To a solution of 4.4 g of sodium dodecyl sulfate dissolved in 200 ml of pure water were added 18 g of solid powder of coloring agent (compound represented by Formula (X-1) relating to the present invention, or comparative coloring agent), a metal-containing compound (the added amount is listed in Table), and a pigment having a quinacridone structure (the added amount is listed in Table). Then, the mixed composition was stirred and subjected to an ultra-sonic treatment to prepare an aqueous dispersion liquid of a coloring agent. Separately, there was prepared an emulsified dispersion liquid having a solid density of 28% by emulsifying low molecular weight polypropylene (number average molecular weight: 3,200) in water by the aid a surfactant with heating.

To the above-described emulsified dispersion liquid was added 60 g of the emulsified dispersion of low molecular weight polypropylene. Further, there were added 220 g of styrene, 40 g of n-butyl acrylate, 12 g of methacrylic acid, 5.4 g of t-dodecyl mercaptan as a chain transfer agent and 2,000 ml of degassed pure water. Then, the mixture was stirred under a nitrogen flow and kept at 70° C. for 3 hours to carry out emulsion polymerization.

To 1,000 ml of the prepared resin particle dispersion liquid was added sodium hydroxide so as to adjust the pH value to be 7.0. Then, 270 ml of aqueous 2.7 mol % potassium hydroxide solution was added. Further, there was added a solution of 160 ml of i-propyl alcohol and 9.0 g of polyoxyethylene octyl phenyl ether having an average polymerization degree of ethylene oxide of 10 dissolved in 67 ml of pure water. The mixture was stirred to react while keeping at 75° C. for 6 hours. The obtained reaction mixture was filtered and washed with water, and the product was dried and pulverized to obtain colored particles.

The prepared colored particles and 1.0 part of silica particles R805 (particle diameter: 12 nm; and hydrophobicity: 60, made by Nippon Aerosil Co., Ltd.) were mixed with a Henschel mixer to obtain a polymerization color toner.

Comparative colorant A: DX-2 described in JP-A No. 2009-221280.

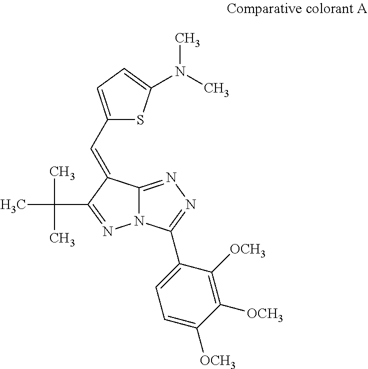 [SMILES: COc1ccc(-c2nnc3/c(=C\c4ccc(N(C)C)s4)c(C(C)(C)C)nn23)c(OC)c1OC]

Comparative colorant B: DX-7 described in JP-A No. 2009-221280.

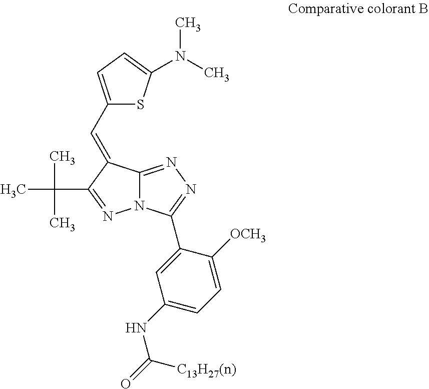

### Preparation of Yellow Toner 1:

Yellow toner 1 was prepared in the same manner as Preparation method 2 of toner except that the coloring agent was replaced with Pigment Yellow 74.

### Preparation of Cyan Toner 1:

Cyan toner 1 was prepared in the same manner as Preparation method 2 of toner except that the coloring agent was replaced with Pigment Blue 15:3.

### Preparation of Black Toner 1:

Black toner 1 was prepared in the same manner as Preparation method 2 of toner except that the coloring agent was replaced with Carbon black “MUGUL L” made by Cabot Corporation.

### <Preparation of Developer for Practical Picture Test>

To the above-described inventive and comparative magenta electrophotographic toners 1-33, Yellow toner 1, Cyan toner 1, and Black toner 1 each was added ferrite carriers having an average particle diameter of 60 μm and covered with a silicone resin. Thus there were prepared inventive and comparative magenta electrophotogTaphic developers 1-33, Yellow developer 1, Cyan developer 1, and Black developer 1 each having a toner density of 6%.

### <Image Formation Method>

Evaluation of image formation was done using a color copier (KL-2010: made by Konica Minolta Business Technologies, Inc.) as an image forming apparatus.

As a fixing device, a usually employed heating roller type fixing device was used. Concretely, a heating roller was constituted by coating the surface of a cylindrical metal core (inner diameter: 40 mm, wall thickness: 1.0 mm, entire width: 310 mm) including a heater at the center portion thereof and covered by a layer of tetrafluoroethylene perfluoroalkyl vinyl ether copolymer (PFA) having a thickness of 120 μm, and a pressing roller was constituted by covering a cylindrical metal core (inner diameter: 40 mm, wall thickness: 2.0 mm) by silicone rubber sponge (Acker C hardness: 48; thickness: 2 mm). The aforesaid heating roller and pressing roller were contacted with each other by a pressure of 150 N to form a nip of 5.8 mm width.

The line speed of printing was set at 480 mm/sec using the above fixing device. For cleaning the fixing device, a supplying system using a web impregnated with polydiphenyl silicone (having a viscosity of 10 Pa·s at 20° C.) was used. The fixing temperature was controlled according to the surface temperature of the heating roller set at 175° C. The coating amount of the silicone oil was 0.1 mg/A4.

### <Development Conditions and Evaluation Conditions>

Color reproductivity test was carried out by making practical picture on paper and OHP sheet under the atmosphere of normal temperature and normal humidity (temperature: 25° C.; and relative humidity: 55%). The development conditions are shown below.

The development conditions were set as follows.

Surface electric potential of photoreceptor: −700 V

DC bias: −500 V

Dsd (Distance between a photoreceptor and a developing sleeve): 600 μm

Regulation of a developer layer: Magnetic H-Cut method

Developer layer thickness: 700 μm

Developing sleeve diameter: 40 mm.

### (Color Reproductivity: Hue Angle)

By using inventive and comparative magenta electrophotographic developers 1-29, a solid image was produced on a transfer material “POD 80” (glossiness: 67) (made by Oji Paper Co., Ltd.). The chroma of each image was measured with a colorimeter “SMP 50” (made by (made by GRETAG Ltd.). A hue angle (H) was calculated from a* value and b* value obtained when the solid image showed a maximum chroma.

A toner having a hue angle in the range of: 341°≦H≦351° was ranked as “A”.

A toner having a hue angle in the range of: 336°≦H≦341°, 351°≦H≦356° was ranked as “B”.

A toner having a hue angle in the range of: 336°≦H, H<356° was ranked as “C”.

The toner of the present invention has a hue angle in the range of A rank.

### (Evaluation of Color Reproductivity Area)

There were produced monochromatic images by using Yellow, Magenta, Cyan, and Black developer and secondary color images of red, green and blue by using theses developers. The solid image portions of the produced color images were measured with a colorimeter “SMP 50”, and the expansion of the area was confirmed (the area was compared with a color area of Japan Color for printing being set as 100).

When the expansion was 5% or more, rank “A” was given. When the expansion was 1% or more to less than 5%, rank “B” was given. When the expansion was less than 1%, rank “C” was given. And, when no expansion was made, rank “D” was given.

Color reproductivity area was evaluated at 3 levels of lightness (L*=35 (low lightness), L*=50 (middle lightness), and L*=65 (high lightness).

### (Evaluation of Hue)

With respect to the hue, the formed magenta monochromatic image and secondary red color image were used. These images were visually evaluated by 10 monitors with maximum points of 10. The ranks were as follows.

A: an average point of 10 monitors is from 9 to 10 points

B: an average point of 10 monitors is from 8 to 9 points

C: an average point of 10 monitors is from 7 to 8 points

D: an average point of 10 monitors is less than 7 points

The ranks A and B were a level sufficient for practical use.

Hue was evaluated at 3 levels of lightness (L*=35 (low lightness), L*=50 (middle lightness), and L*=65 (high lightness).

The evaluation results are shown in the following Table 1.

TABLE 1

| | | | | Quinacridone | | | | Evaluation of Color | | | | | | |
|---|---|---|---|---|---|---|---|---|---|---|---|---|---|---|
| | Com- | Metal-containing | | type pigment | | Preparation | | reproductivity area | | | | | | |
| Toner | pound | compound | | Name of | | method | Hue | evaluation | | | Evaluation of Hue | | | Re- |
| No. | No. | No. | Amount (g) | compound | Amount (g) | number | angle | L* = 35 | L* = 50 | L* = 65 | L* = 35 | L* = 50 | L* = 65 | marks |
| 1 | MX-2 | — | — | — | — | 2 | A | B | B | B | B | B | B | Inv. |
| 2 | MX-2 | 8 | 40 | — | — | 2 | A | B | B | A | B | A | A | Inv. |
| 3 | MX-2 | — | — | P.R.122 | 30 | 2 | A | A | B | B | A | B | B | Inv. |
| 4 | MX-2 | 8 | 40 | P.R.122 | 30 | 2 | A | A | A | A | A | A | A | Inv. |
| 5 | MX-1 | 8 | 40 | — | — | 2 | A | B | B | A | B | B | A | Inv. |
| 6 | MX-1 | — | — | P.R.122 | 30 | 2 | A | A | B | B | A | B | B | Inv. |
| 7 | MX-1 | 8 | 40 | P.R.122 | 30 | 2 | A | A | B | A | A | B | A | Inv. |
| 8 | MX-3 | — | — | — | — | 2 | A | B | B | B | B | B | B | Inv. |
| 9 | MX-3 | 8 | 40 | — | — | 2 | A | B | B | A | B | B | A | Inv. |
| 10 | MX-3 | — | — | P.R.192 | 30 | 2 | A | A | B | A | B | B | A | Inv. |
| 11 | MX-3 | 8 | 40 | P.R.192 | 30 | 2 | A | A | B | A | B | A | A | Inv. |
| 12 | MX-4 | 8 | 40 | P.R.122 | 30 | 2 | A | A | B | A | A | B | A | Inv. |
| 13 | MX-8 | 8 | 40 | P.R.122 | 30 | 2 | A | A | B | A | A | B | A | Inv. |
| 14 | MX-9 | 8 | 40 | P.R.122 | 30 | 2 | A | A | B | A | A | B | A | Inv. |
| 15 | MX-10 | 11 | 40 | P.R.192 | 30 | 1 | A | A | B | A | A | B | B | Inv. |
| 16 | MX-27 | 11 | 40 | P.R.192 | 30 | 1 | A | A | B | A | A | B | B | Inv. |
| 17 | MX-28 | 8 | 40 | P.R.122 | 30 | 1 | A | A | B | A | A | B | B | Inv. |
| 18 | MX-24 | 8 | 40 | P.R.122 | 30 | 2 | A | A | B | A | A | B | A | Inv. |
| 19 | MX-41 | 11 | 40 | P.R.192 | 30 | 2 | A | A | B | A | A | B | A | Inv. |
| 20 | MX-42 | 16 | 40 | P.R.122 | 30 | 2 | A | A | B | A | A | B | A | Inv. |
| 21 | MX-43 | 11 | 40 | P.R.122 | 30 | 2 | A | A | B | A | A | B | A | Inv. |
| 22 | MX-27 | 8 | 40 | P.R.122 | 30 | 2 | A | A | B | A | A | B | A | Inv. |
| 23 | MX-47 | 8 | 40 | P.R.122 | 30 | 2 | A | A | B | A | A | B | A | Inv. |
| 24 | ** A | — | — | — | — | 2 | A | C | B | C | B | B | B | Comp. |
| 25 | ** A | 8 | 40 | — | — | 2 | A | C | C | B | C | B | B | Comp. |
| 26 | ** A | — | — | P.R.122 | 30 | 2 | A | B | C | C | B | B | C | Comp. |
| 27 | ** B | — | — | — | — | 2 | A | C | C | C | B | B | C | Comp. |
| 28 | ** B | 8 | 40 | — | — | 2 | A | C | C | C | C | B | C | Comp. |
| 29 | ** B | — | — | P.R.122 | 30 | 2 | A | C | C | C | B | C | C | Comp. |

Amount: added amount (g),
P.R. 122: C.I. Pigment Red 122,
P.R. 192: C.I. Pigment Red 192,
**: Comparative colorant
Inv.: Present invention,
Comp.: Comparative example

As clearly shown by the result in Table 1, when the toner of the present invention was used, a color reproductivity area was expanded from low lightness to high lightness, and a hue was also improved. By using with comparative toners, it was found that there was obtained an improved effect only in either low lightness or high lightness for both a color reproductivity area and a hue.

1. An electrophotographic toner comprising a compound represented by Formula (X-1),
wherein a hue angle (H) of the toner in CIE L*a*b* color space is in the range of:
341°≦H≦351°,
when a toner image formed only with the toner exhibits a maximum chroma, 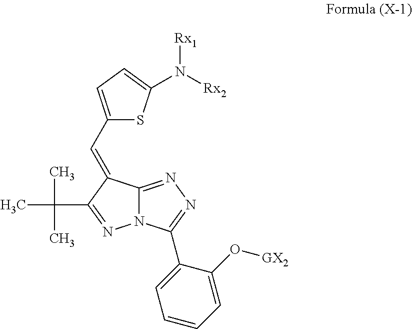
wherein, one of Rx₁ and Rx₂ represents a methyl group or an ethyl group, and another one of Rx₁ and Rx₂ represents an alkyl group having 12 or less carbon atoms which may be substituted with an oxygen-containing group, or Rx₁ and Rx₂ represent a 5- or 6-membered heterocyclic ring which may be substituted with an oxygen-containing group by combining Rx₁ and Rx₂ with a nitrogen atom; and GX₂ represents an alkyl group which may be substituted with an oxygen-containing group.

2. The electrophotographic toner described in claim 1,
wherein the toner further contains a pigment having a quinacridone structure in addition to the compound represented by Formula (X-1); and
a hue angle (H) of the toner in CIE L*a*b* color space is in the range of:
341°≦H≦351°,
when a toner image formed only with the toner exhibits a maximum chroma.

3. The electrophotographic toner described in claim 1,
wherein the toner further contains a compound represented by Formula (1) in addition to the compound represented by Formula (X-1); and
a hue angle (H) of the toner in CIE L*a*b* color space is in the range of:
341°≦H≦351°,
when a toner image formed only with the toner exhibits a maximum chroma, 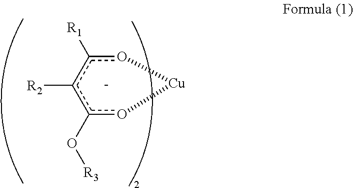
wherein R₁ represents an alkyl group; R₂ represents a hydrogen atom, an alkoxycarbonyl group, an aryloxycarbonyl group, a sulfamoyl group, a sulfinyl group, an alkylsulfonyl group, an arylsulfonyl group, an acyl group, a halogen atom, or a cyano group; and R₃ represents a group containing an aromatic hydrocarbon structure having 9 or more carbon atoms.

4. An electrophotographic toner comprising a compound represented by Formula (X-1b), Formula (X-1b) 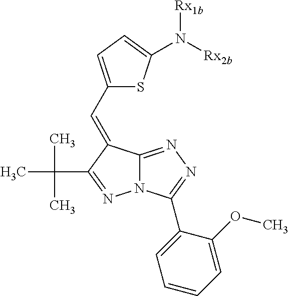
wherein one of Rx_{1b} and Rx_{2b} represents a methyl group or an ethyl group, and another one of Rx_{1b} and Rx_{2b} represents an alkyl group having 4 or less carbon atoms which may be substituted with an oxygen-containing group, provided that a sum of carbon atoms of Rx_{1b} and Rx_{2b} is an integer of 3 to 5, or Rx_{1b} and Rx_{2b} represent a 5- or 6-membered heterocyclic ring which may be substituted with an oxygen-containing group by combining Rx_{1b} and Rx_{2b} with a nitrogen atom.

5. The electrophotographic toner described in claim 4,
wherein a hue angle (H) of the toner in CIE L*a*b* color space is in the range of:
341°≦H≦351°,
when a toner image formed only with the toner exhibits a maximum chroma.

6. The electrophotographic toner,
wherein the toner image formed only with the toner described in claim 1 is formed by fixing using a heat roller fixing method composing a heat roller and a pressure roller.

7. The electrophotographic toner,
wherein the toner image formed only with the toner described in claim 1 is formed by being developed under the following conditions,
surface electric potential of a photoreceptor: −700 V
DC bias: −500 V
distance between a photoreceptor and a developing sleeve: 600 μm
regulation of a developer layer: magnetic H-Cut method
developer layer thickness: 700 μm
developing sleeve diameter: 40 mm.

8. The electrophotogaphic toner,
wherein the toner image formed only with the toner described in claim 1 is formed by being transferred on a transfer material having a glossiness of 5 to 80.

9. A method for forming an image using the electrophotographic toner described in claim 1.

10. The electrophotographic toner described in claim 1,
wherein one of Rx₁ and Rx₂ in Formula (X-1) represents a methyl group or an ethyl group, and another one of Rx₁ and Rx² represents an alkyl group having 6 or less carbon atoms which may be substituted with an oxygen-containing group.

11. The electrophotographic toner described in claim 1,
wherein one of Rx₁ and Rx₂ in Formula (X-1) represents a methyl group or an ethyl group, and another one of Rx₁ and Rx₂ represents an alkyl group having 4 or less carbon atoms which may be substituted with an oxygen-containing group.

12. The electrophotographic toner described in claim 1,
wherein GX₂ in Formula (X-1) represents an alkyl group having 1 to 5 carbon atoms which may be substituted with an oxygen-containing group.

13. The electrophotographic toner described in claim 1,
wherein GX₂ in Formula (X-1) represents a methyl group or an ethyl group.

14. The electrophotographic toner described in claim 4,
wherein one of Rx_{1b} and Rx_{2b} in Formula (X-1b) represents a methyl group or an ethyl group, and another one of Rx_{1b} and Rx_{2b} represents an alkyl group having 3 or less carbon atoms which may be substituted with an oxygen-containing group, provided that a sum of carbon atoms of Rx_{1b} and Rx_{2b} is an integer of 3 to 4.

15. The electrophotographic toner described in claim 4,
wherein one of Rx_{1b} and Rx_{2b} in Formula (X-1b) represents a methyl group, and another one of Rx_{1b} and Rx_{2b} represents an ethyl group.
